(19) United States
(12) Patent Application Publication
(10) Pub. No.: US 2024/0137383 A1
(43) Pub. Date: Apr. 25, 2024

(54) WELLNESS DETECTION AND RESPONSE FOR SMALL BUSINESSES

(71) Applicant: McAfee, LLC, San Jose, CA (US)

(72) Inventors: Dattatraya Kulkarni, Bangalore (IN); Raghavendra Satyanarayana Hebbalalu, Karnataka (IN); Srikanth Nalluri, Bangalore (IN); Urmil Mahendra Parikh, Bangalore (IN); Shashank Jain, Bangalore (IN); Himanshu Srivastava, Bangalore (IN); Piyush Pramod Joshi, Aurangabad (IN); Partha Sarathi Barik, Bangalore (IN); Purushothaman Balamurugan, Salem (IN); Saravana Kumar Ramalingam, Bangalore (IN); Devanshi Saxena, Lucknow (IN); Martin Pivetta, Dallas, TX (US); Sujay Subrahmanya, Bangalore (IN); Shahmeet Singh, Bangalore (IN); Ryan Burrows, Rivestone (AU); Samrat Chitta, Yellakunte (IN)

(73) Assignee: McAfee, LLC, San Jose, CA (US)

(21) Appl. No.: 18/542,241

(22) Filed: Dec. 15, 2023

Related U.S. Application Data
(63) Continuation of application No. 18/088,385, filed on Dec. 23, 2022.

(30) Foreign Application Priority Data
Sep. 29, 2022 (IN) 202241055967

(51) Int. Cl. H04L 9/40

(52) U.S. Cl. CPC H04L 63/1433; H04L 63/20

(57) ABSTRACT

There is disclosed herein a computer-implemented system and method of providing wellness detect and response (WDR) security services for an enterprise, including computing, for the enterprise, a quantitative user-centric security posture, wherein computing the quantitative user-centric security posture comprises calculating, for a user, a quantitative user risk profile according to a combination of user role, user privileges, user behavior, and digital assets assigned to a user and owned by the enterprise.

### FIELD OF THE SPECIFICATION

This application relates in general to computer security, and more particularly though not exclusively to wellness detection and response (WDR) services for small businesses.

### BACKGROUND

Small businesses may require security services to operate without interference from various security threats.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of a small business security ecosystem.

FIG. 2 is a block diagram representation of selected small business assets.

FIG. 3 is a block diagram of selected elements of a user device.

FIG. 4 is a block diagram illustration of selected elements of a risk assessment ecosystem.

FIG. 5 illustrates another dimension of a risk assessment ecosystem, including a user risk profile.

FIG. 6 is a block diagram representation of selected aspects of security state management.

FIG. 7 is a block diagram illustration of an illustrative user interface elements.

FIG. 8 is a block diagram illustration of selected elements of a user protection ecosystem.

FIG. 9 illustrates a dashboard that is provided to a user named John.

FIG. 10 is a block diagram illustration of a UI element.

FIG. 11 is a block diagram illustration of a UI element.

FIG. 12 is a block diagram representation of selected elements of a system.

FIG. 13 is a block diagram of selected small business assets.

FIG. 14a is a block diagram of a digital wellness domain.

FIG. 14b is a block diagram of small business insights.

FIG. 15 is a block diagram of selected aspects of a wellness detect and response (WDR) ecosystem.

FIG. 16 is a block diagram of selected aspects of an insights engine.

FIG. 17 is a block diagram illustration of small business event processing.

FIG. 18 is a block diagram of selected elements of a containerization infrastructure.

FIG. 19 is a block diagram of selected elements of a hardware platform.

FIG. 20 is a block diagram of selected elements of a network function virtualization (NFV) infrastructure.

### SUMMARY

There is disclosed herein a computer-implemented system and method of providing wellness detect and response (WDR) security services for an enterprise, including computing, for the enterprise, a quantitative user-centric security posture, wherein computing the quantitative user-centric security posture comprises calculating, for a user, a quantitative user risk profile according to a combination of user role, user privileges, user behavior, and digital assets assigned to a user and owned by the enterprise.

### Embodiments of the Disclosure

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

### Overview

As used in this specification, a small business generally includes a business with between 1 and upper bound of employees, which upper bound may be on the order of 100 to 250 employees. In some cases, a small business may be defined more particularly in terms of how it operates, such as with a “small business mentality.” Small businesses tend to be agile, less formal, and more intimate than medium to large businesses. The WDR system of the present specification may also benefit families, individual, medium-sized businesses, charities, church, schools, and other organizations. Furthermore, although the present disclosure is described in terms of benefits to small businesses, large businesses may also use the WDR system disclosed herein.

Small businesses may face many of the same security challenges as medium to large businesses but may not have the luxury of hiring or contracting dedicated IT managers and cyber security experts. Rather, in small businesses, the small business owner or another employee may end up taking on the burden of managing security as a part-time activity. As the security environment continues to increase in complexity with an increasing number of devices, applications, cloud services, and other considerations, small business owners and their employees may become overwhelmed with the security tasks. Furthermore, the small business owner or employee managing security may not be a full-time security expert but, rather, may have some ordinary or passing familiarity with security and thus may be tasked with managing assets that impose a substantial time and energy burden. As the number of small businesses proliferate, security threats for small businesses may become similar to those facing medium and larger enterprises.

To manage its security posture, a small business may deploy consumer solutions or, in some cases, an enterprise-class solution that has been repurposed for small businesses. (Although the term “enterprise” is very broad, the phrase “enterprise-class,” as used in this specification, may be understood to represent solutions that are intended for and targeted towards large businesses, e.g., businesses with more than 250 employees). These approaches may have drawbacks. For example, some consumer solutions may be inadequate to meet the small business' needs. Consumer solutions may not provide a view of how assets are protected and may lack mechanisms to alert users of important security events. Consumer class solutions may also lack manageability features beyond simply turning on the security software and possibly configuring a few high-level options.

On the other hand, enterprise-class security solutions may be difficult for a small business user to understand and manage and may require expertise to deploy, monitor, and manage. Enterprise-class solutions may also be prohibitively expensive for some small business users.

Small business owners and operators may benefit from simplified security solutions with ease of use similar to consumer or household options, while also having a level of insight and control that provides greater confidence in their security solution. Thus, the present specification provides a system and method that is targeted specifically to the needs of small businesses.

One illustrative service that may be provided for small businesses is wellness detection and response (WDR), including systems and methods for assessing and assuring digital wellness of small business environments.

At present, the cybersecurity industry provides mature Endpoint Detection and Response (EDR) capabilities that combine, for example, continuous monitoring, analytics, and mitigation techniques. EDR may enable human security experts to analyze data to hunt for threats, derive patterns, investigate anomalies, and advise on preventative and remedial action. In some examples, fully automated remediations may be combined with human expert triage, investigation, and remediation of incidents.

Because security problems are relatively complex, EDR solutions may also be complex. As discussed above, small businesses may lack subject matter experts and dedicated information technology (IT), security operations (SecOps), and security training personnel to manage complex networks and security ecosystems. And yet, while lacking such dedicated personnel, small businesses can be the subject of targeted and sophisticated malicious actions. And even when they have dedicated personnel, existing enterprise-grade security tools may be substantially complex and require significant training for those personnel. Furthermore, existing EDR solutions may be designed with large enterprises in mind, and may focus on core security challenges for those large enterprises, rather than holistic digital wellness challenges for the small businesses. Thus, small businesses may benefit from wellness detection and response tools that address their particular needs.

This specification provides a WDR system that includes integrated methods to monitor “wellness” events across a broad spectrum of digital assets that matter to small business environments, ranging from events on devices to online accounts to social media to software-as-a-service (SaaS) applications to user behaviors. One advantage of the system disclosed is that events are considered across a broad digital work landscape, rather than considering just events on endpoint devices. The system may analyze security events to offer recommendations for prevention and remediation. The system may also progressively and dynamically escalate the location and remediation of events to experts (who can be shared between small businesses or other enterprises), who may analyze the security, privacy, and identity postures and risks to make expert recommendations for remediations.

This present disclosure provides a system and method to derive wellness insights from events and traces from digital wellness. These insights may include, for example, security, privacy, and identity across devices, emails, banking accounts, social media and other assets that indicate risks across a variety of usage scenarios. There is also disclosed a system and method to progressively recommend, enhance, and remediate wellness risks based on local rules-based wellness outcomes. The method may be used to provide analysis, wellness insights, and correlation with events across assets, historical data. In various embodiments, the system may incorporate inputs from one or more dedicated or shared (e.g., between enterprises) human security experts.

This provides advantages. For example, EDR solutions in the industry tend to be complex, even for medium sized businesses. The method of the present specification provides enough of the known EDR objectives to provide insights, for example to small businesses (although individuals and enterprises of any size may benefit from these teachings). Insights may be extended to include not just endpoints or specific devices, but to include all digital assets owned by the enterprise. Advantageously, the insights provided by the present specification may provide immediate remediation recommendations, including some recommendations beyond those that may be provided by endpoint products. The system herein may also progressively provide the score of a threat analysis and response to a security expert.

### SELECTED EXAMPLES

The foregoing can be used to build or embody several example implementations, according to the teachings of the present specification. Some example implementations are included here as nonlimiting illustrations of these teachings.

Example 1 includes a computer-implemented method of providing security services for an enterprise, comprising:
computing, for the enterprise, a quantitative user-centric security posture, wherein computing the quantitative user-centric security posture comprises calculating, for a user, a quantitative user risk profile according to a combination of user role, user privileges, user behavior, and digital assets assigned to a user and owned by the enterprise.

Example 2 includes the computer-implemented method of example 1, wherein the enterprise is a small or medium-sized business, family, church, religious organization, club, or educational institution.

Example 3 includes the computer-implemented method of example 2, wherein the user is an employee, agent, or member of the enterprise.

Example 4 includes the computer-implemented method of example 1, wherein digital assets further include assets owned by the user and used for enterprise operations.

Example 5 includes the computer-implemented method of example 1, wherein digital assets are selected from the group consisting of electronic devices, applications, identities, shared sensitive information, online accounts, and online services.

Example 6 includes the computer-implemented method of example 1, wherein computing a user risk profile comprises computing a sum of weighted scores for a plurality of risk categories.

Example 7 includes the computer-implemented method of example 6, wherein the weighted scores are uniformly values between 0 and 1.

Example 8 includes the computer-implemented method of example 6, wherein the sum of weighted scores total substantially 1.0.

Example 9 includes the computer-implemented method of example 6, wherein the risk categories comprise security, privacy, and identity.

Example 10 includes the computer-implemented method of example 1, wherein the quantitative user risk profile for the user numerically represents a combined security state of digital assets assigned to the user.

Example 11 includes the computer-implemented method of example 1, further comprising defining a user-specific digital protection policy for the user based on the quantitative user risk profile.

Example 12 includes the computer-implemented method of example 1, further comprising defining a group- or subgroup-specific digital protection policy based on user risk profiles for members of the group or subgroup.

Example 13 includes the computer-implemented method of example 11 or 12, further comprising enforcing the specific digital protection policy via security automation.

Example 14 includes the computer-implemented method of example 11 or 12, wherein the specific digital protection policy comprises security, identity, and/or privacy policies.

Example 15 includes the computer-implemented method of example 11 or 12, further comprising presenting to a human security operator an actional graphical display comprising a set of prioritized protection actions to enforce the specific digital protection policy.

Example 16 includes the computer-implemented method of example 15, wherein the actionable graphical display abstracts at least one security action above a direct computer implementation of the security action.

Example 17 includes the computer-implemented method of example 15, wherein the actional graphical display includes a graphical indication of clean assets and problematic assets, wherein clean assets comprise assets that do not have identified digital protection issues, and problematic assets comprise assets that do have identified digital protection issues.

Example 18 includes the computer-implemented method of example 1, further comprising providing a weekly report to show remedial actions for one or more users, groups, or subgroups to take to remediate one or more problematic digital protection states.

Example 19 includes the computer-implemented method of example 18, wherein the weekly report further provides digital protection score trends and remedial action trends.

Example 20 includes the apparatus comprising means for performing the method of any of examples 1-19.

Example 21 includes the apparatus of example 20, wherein the means for performing the method comprise a processor and a memory.

Example 22 includes the apparatus of example 21, wherein the memory comprises machine-readable instructions that, when executed, cause the apparatus to perform the method of any of examples 1-19.

Example 23 includes the apparatus of any of examples 20-22, wherein the apparatus is a computing system.

Example 24 includes the least one computer readable medium comprising instructions that, when executed, implement a method or realize an apparatus as in any of examples 1-23.

Example 2 includes one or more tangible, nontransitory computer-readable storage media having stored thereon executable instructions to: compute, for an enterprise, a quantitative user-centric security posture, wherein computing the quantitative user-centric security posture comprises calculating, for a user, a quantitative user risk profile according to a combination of user role, user privileges, user behavior, and digital assets assigned to a user and owned by the enterprise.

Example 26 includes the one or more tangible, nontransitory computer-readable storage media of example 25, wherein the enterprise is a small or medium-sized business, family, church, religious organization, club, or educational institution.

Example 72 includes the one or more tangible, nontransitory computer-readable storage media of example 26, wherein the user is an employee, agent, or member of the enterprise.

Example 28 includes the one or more tangible, nontransitory computer-readable storage media of example 25, wherein digital assets further include assets owned by the user and used for enterprise operations.

Example 29 includes the one or more tangible, nontransitory computer-readable storage media of example 25, wherein digital assets are selected from the group consisting of electronic devices, applications, identities, shared sensitive information, online accounts, and online services.

Example 30 includes the one or more tangible, nontransitory computer-readable storage media of example 25, wherein computing a user risk profile comprises computing a sum of weighted scores for a plurality of risk categories.

Example 31 includes the one or more tangible, nontransitory computer-readable storage media of example 30, wherein the weighted scores are uniformly values between 0 and 1.

Example 32 includes the one or more tangible, nontransitory computer-readable storage media of example 30, wherein the sum of weighted scores total substantially 1.0.

Example 33 includes the one or more tangible, nontransitory computer-readable storage media of example 30, wherein the risk categories comprise security, privacy, and identity.

Example 34 includes the one or more tangible, nontransitory computer-readable storage media of example 25, wherein the quantitative user risk profile for the user numerically represents a combined security state of digital assets assigned to the user.

Example 35 includes the one or more tangible, nontransitory computer-readable storage media of example 25, wherein the instructions are further to define a user-specific digital protection policy for the user based on the quantitative user risk profile.

Example 36 includes the one or more tangible, nontransitory computer-readable storage media of example 25, further comprising defining a group- or subgroup-specific digital protection policy based on user risk profiles for members of the group or subgroup.

Example 37 includes the one or more tangible, nontransitory computer-readable storage media of example 35 or 36, further comprising enforcing the specific digital protection policy via security automation.

Example 38 includes the one or more tangible, nontransitory computer-readable storage media of example 35 or 36, wherein the specific digital protection policy comprises security, identity, and/or privacy policies.

Example 39 includes the one or more tangible, nontransitory computer-readable storage media of example 35 or 36, wherein the instructions are further to present to a human security operator an actional graphical display comprising a set of prioritized protection actions to enforce the specific digital protection policy.

Example 40 includes the one or more tangible, nontransitory computer-readable storage media of example 39, wherein the actionable graphical display abstracts at least one security action above a direct computer implementation of the security action.

Example 41 includes the one or more tangible, nontransitory computer-readable storage media of example 39, wherein the actional graphical display includes a graphical indication of clean assets and problematic assets, wherein clean assets comprise assets that do not have identified digital protection issues, and problematic assets comprise assets that do have identified digital protection issues.

Example 42 includes the one or more tangible, nontransitory computer-readable storage media of example 25, wherein the instructions are further to provide a weekly report to show remedial actions for one or more users, groups, or subgroups to take to remediate one or more problematic digital protection states.

Example 43 includes the one or more tangible, nontransitory computer-readable storage media of example 42, wherein the weekly report further provides digital protection score trends and remedial action trends.

Example 44 includes a computing apparatus, comprising: a hardware platform comprising a processor circuit and a memory; and instructions encoded within the memory to instruct the processor circuit to compute, for an enterprise, a quantitative user-centric security posture, wherein computing the quantitative user-centric security posture comprises calculating, for a user, a quantitative user risk profile according to a combination of user role, user privileges, user behavior, and digital assets assigned to a user and owned by the enterprise.

Example 45 includes the computing apparatus of example 44, wherein the enterprise is a small or medium-sized business, family, church, religious organization, club, or educational institution.

Example 46 includes the computing apparatus of example 45, wherein the user is an employee, agent, or member of the enterprise.

Example 47 includes the computing apparatus of example 44, wherein digital assets further include assets owned by the user and used for enterprise operations.

Example 48 includes the computing apparatus of example 44, wherein digital assets are selected from the group consisting of electronic devices, applications, identities, shared sensitive information, online accounts, and online services.

Example 49 includes the computing apparatus of example 44, wherein computing a user risk profile comprises computing a sum of weighted scores for a plurality of risk categories.

Example 50 includes the computing apparatus of example 49, wherein the weighted scores are uniformly values between 0 and 1.

Example 51 includes the computing apparatus of example 50, wherein the sum of weighted scores total substantially 1.0.

Example 52 includes the computing apparatus of example 50, wherein the risk categories comprise security, privacy, and identity.

Example 53 includes the computing apparatus of example 44, wherein the quantitative user risk profile for the user numerically represents a combined security state of digital assets assigned to the user.

Example 54 includes the computing apparatus of example 44, wherein the instructions are further to define a user-specific digital protection policy for the user based on the quantitative user risk profile.

Example 55 includes the computing apparatus of example 44, further comprising defining a group- or subgroup-specific digital protection policy based on user risk profiles for members of the group or subgroup.

Example 56 includes the one or more tangible, nontransitory computer-readable storage media of example 54 or 55, further comprising enforcing the specific digital protection policy via security automation.

Example 57 includes the one or more tangible, nontransitory computer-readable storage media of example 54 or 55, wherein the specific digital protection policy comprises security, identity, and/or privacy policies.

Example 58 includes the one or more tangible, nontransitory computer-readable storage media of example 54 or 55, wherein the instructions are further to present to a human security operator an actional graphical display comprising a set of prioritized protection actions to enforce the specific digital protection policy.

Example 59 includes the computing apparatus of example 58, wherein the actionable graphical display abstracts at least one security action above a direct computer implementation of the security action.

Example 60 includes the computing apparatus of example 58, wherein the actional graphical display includes a graphical indication of clean assets and problematic assets, wherein clean assets comprise assets that do not have identified digital protection issues, and problematic assets comprise assets that do have identified digital protection issues.

Example 61 includes the computing apparatus of example 44, wherein the instructions are further to provide a weekly report to show remedial actions for one or more users, groups, or subgroups to take to remediate one or more problematic digital protection states.

Example 62 includes the computing apparatus of example 61, wherein the weekly report further provides digital protection score trends and remedial action trends.

### Detailed Description of the Drawings

A system and method for wellness detection and response services for small businesses will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

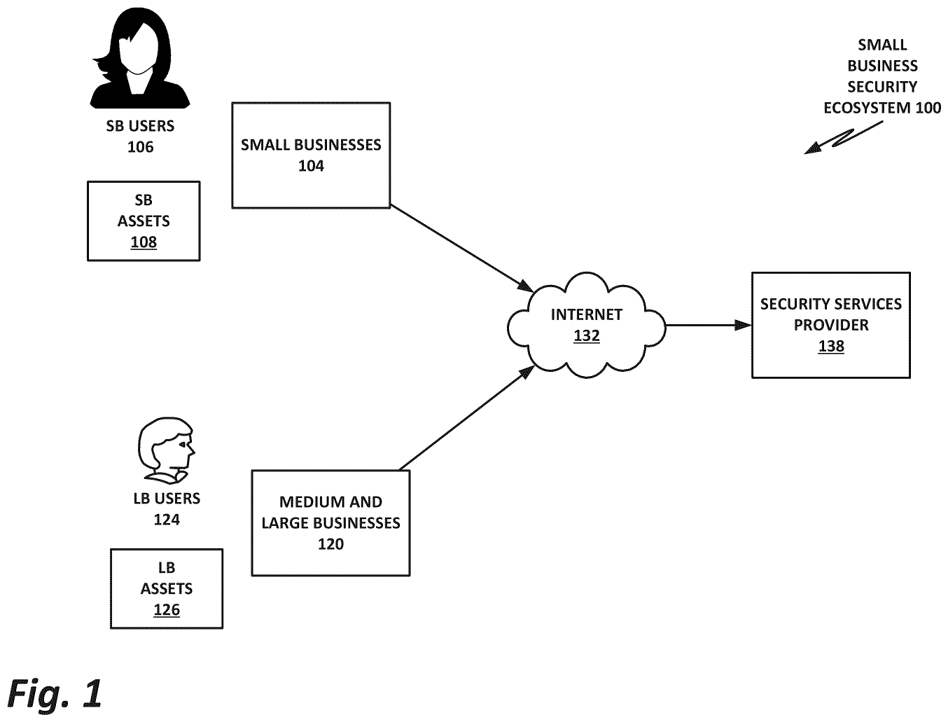

FIG. 1 is a block diagram of selected elements of a small business security ecosystem 100. Small business security ecosystem 100 may include a security services provider 138. Security services provider 138 may be an enterprise that specializes in security solutions for businesses of many different types. For example, McAfee is a leading provider of security solutions for large, medium, and small businesses, as well as for consumers. Thus, as used throughout this specification and the appended claims, the term “enterprise” should be understood to encompass an organization or group of any size, including small, medium, and large businesses, small home offices, families, clubs, churches and other religious organizations, educational institutions, charities, and any other group that may operate a network and own digital assets. In most cases, the enterprise of any size will have a person who serves in the “network administrator” role as a person who is responsible for managing and

Security services provider 138 may communicatively couple to client enterprises via internet 132. The clients may include medium and large businesses 120 as well as small businesses 104. Medium and large businesses 120 may include large business users 124 and large business assets 126 that are managed by their respective enterprises.

Small businesses 104 may likewise include small business users 106 and small business assets 108. Small businesses 104 and large businesses 120 may have vastly different available resources for managing and deploying security solutions. For example, medium and large businesses 120 may have access to dedicated security experts who focus full-time on managing security for the medium and large businesses. For some sufficiently large businesses, cybersecurity asset management may be an entire department for the business.

In contrast, small business 104 may have individual owner-operators or small employee teams and may lack a dedicated security expert. A common small business owner may not have cybersecurity certifications, specialized training in cybersecurity solutions, or dedicated expertise. Rather, the small business owner-operators and employees may be hardworking and dedicated and may have general knowledge of cybersecurity practices but may not be able to dedicate full-time efforts to managing security for the small business. It is therefore beneficial for security services provider 138 to provide to small businesses 104 a simplified view of a security posture for the small business assets. This may include, for example, users, devices, data and storage, business applications, and other assets that the small business may need to manage. Security services provider 138 may provide small business owners with simplified ways to view specific security issues and automated ways to remediate those issues. It is beneficial to provide the small business owner-operators with the ability to define simple policies and to monitor compliance to those policies both by themselves and by their employees. It is also beneficial to provide a system and associated methods that provide simplicity on par with a consumer-oriented solution, while also having a level of insight and control that provides the small business owner confidence with the small businesses security posture.

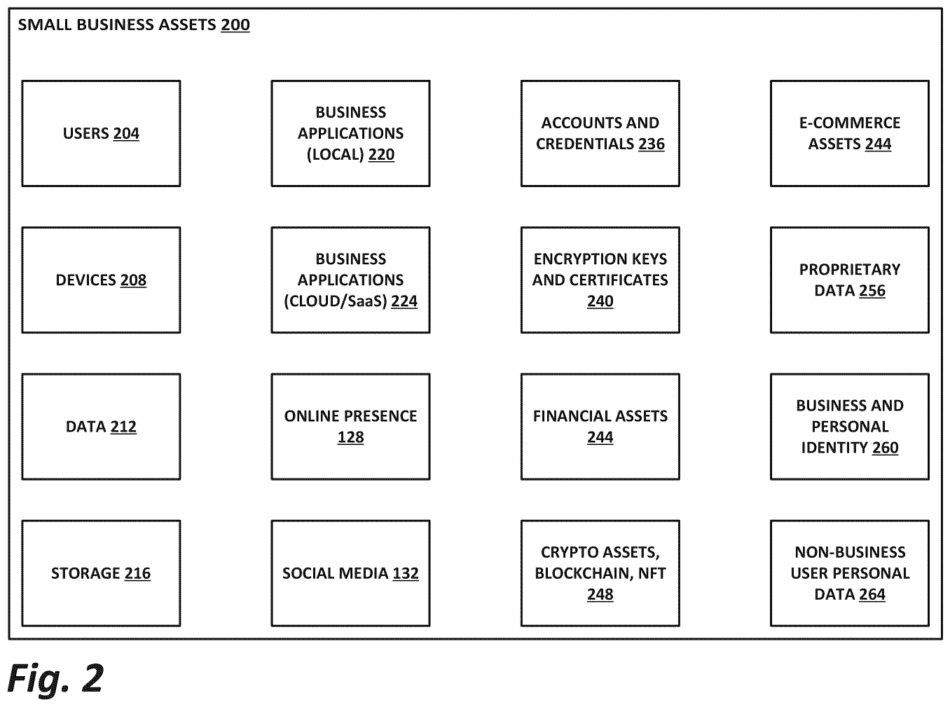

FIG. 2 is a block diagram representation of illustrative small business assets 200. As used throughout this specification, the term “asset” should be understood to include any of the assets listed here, along with any other assets that a small business may need to manage. In this example, assets include users 204, including human users, such as the small business owner-operator or the small business employees.

Devices 208 may include devices owned and operated by the small business as well as a bring your own device (BYOD) paradigm. Thus, devices 208 may represent a heterogeneous mixture of enterprise-owned assets as well as user-owned assets that perform business functions. The BYOD model is beneficial for many smaller businesses because it saves the overhead of managing and tracking physical assets. In some cases, the business owner may reimburse employees for purchasing their own computing equipment, or employees or contractors may provide their own equipment to perform business functions. While this saves overhead for the small business, it may introduce some complexities in terms of managing assets and data.

Data 212 may include data generated by the small business and may be tightly coupled with storage 216. For example, a small law firm may generate large volumes of Microsoft Word documents as well as other data, such as discovery data, client files, government correspondence, and other files and objects. These may be managed, for example, by providing a database file system or backup solution that maintains the small business data on storage 216.

The small business may also have applications including local business applications 220 and cloud or software as a service (SAAS) applications 224. For many small businesses, particularly office-based small businesses, their applications (both local and cloud-based) form a backbone of the business. This includes applications that allow the users to create and manage data 212. As in the case of devices, depending on the structure of the small business, application licenses may be owned by the employees or by the business. Businesses may also use open source applications. Tracking license compliance for both proprietary and open source applications may be a nontrivial concern for the small business.

The small business may also have an online presence 128. This may include, for example, its ownership of certain domain names, rights to control online profiles, administrative access to the business profile, such as on a review site, and other tools for managing the business' online presence.

The business may have a social media presence 132, which may include blogs, websites, and social media accounts on services such as Facebook, Instagram, Twitter, TikTok, VSCO, and others.

The business may also own certain accounts and credentials 236. This may include usernames and passwords to access certain online services and, in some cases, may be intertwined with business applications 220, cloud applications 224, online presence 128, social media 132, and other assets. Accounts and credentials may also include access to online banking sites, subscriptions to news services, and other accounts and credentials.

The small business may own a number of encryption keys and/or certificates 240. These may include, for example, encryption keys for encrypting or decrypting data 212, keys for managing encryption for websites, certificates, such as SSL/TLS certificates, for its online presence, or other keys and certificates that are used to manage data and, in particular, encrypted data.

The small business may have financial assets 244, including cash deposits, stocks, stock options, shares, investments, and other assets that are owned and controlled by the business.

In some cases, a small business may include crypto assets, such as block chain currency, nonrefundable tokens (NFT), or other cryptographic assets 248.

The small business may have e-commerce assets 244. These may include business-to-business (B2B) transactions, e-commerce sites, credit card processing accounts, and other accounts, credentials, or assets for engaging in electronic commerce.

A subset of data managed by the small business may include proprietary data 256, which may include data that are more sensitive than standard data, that contain trade secrets, business know-how, contacts, business relationships, and other data that may provide a competitive advantage to the business and that should be protected from intrusion.

The small business may also have access to and/or maintain business and personal identity 260. These data may include information about the business, information such as a taxpayer identification number, an employer identification number, Social Security numbers, telephone numbers, addresses, bank account numbers, and other information that can be used to identify the business or individuals within the business, and that may also be useful for creating and managing accounts.

The business may also have access to or be adjacent to certain nonbusiness user personal data 264. These data may be data that identify individual users, such as Social Security numbers, home addresses, phone numbers, contact information, social media accounts, usernames and passwords, and private information. In the particular instance of the BYOD paradigm, users may keep both business and personal data on a single device, and it is therefore useful for the business to segregate business data from personal data and control access in a two-way fashion. For example, the enterprise should maintain control over how and when employees access business-critical data, while also ensuring that the enterprise does not compromise the user's personal data.

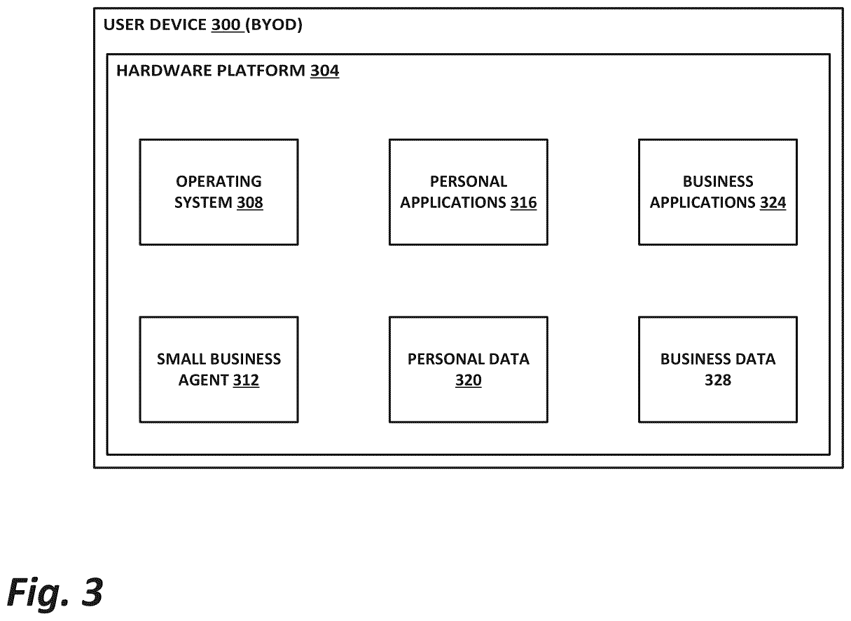

FIG. 3 is a block diagram of selected elements of a user device 300. User device 300 may be operated in a BYOD paradigm and may be physically owned by a user of the small business.

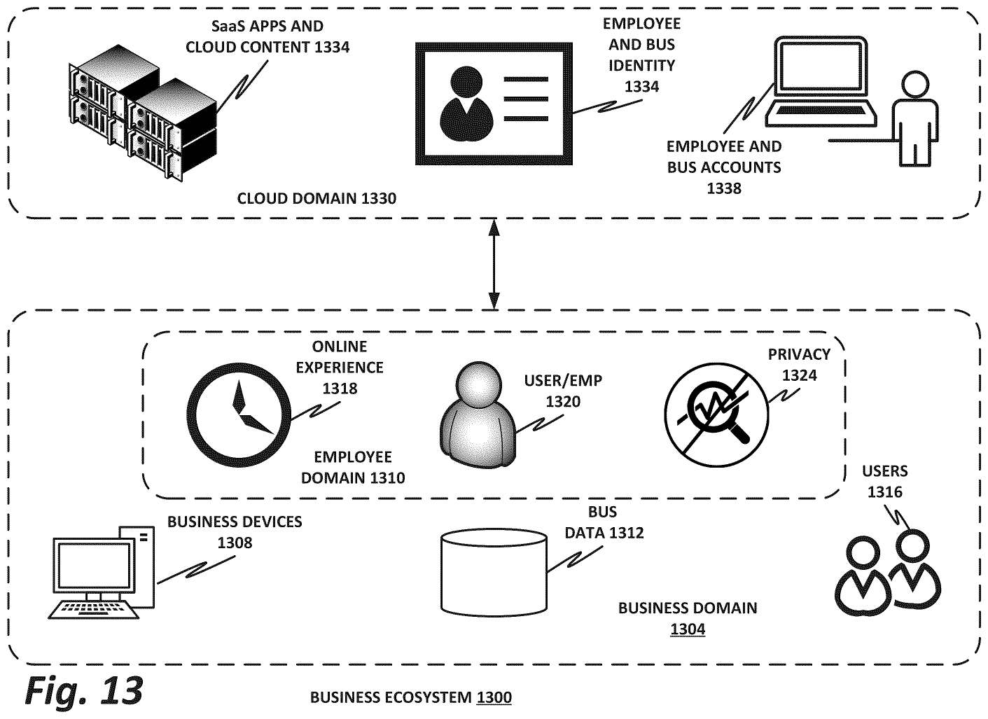

User device 300 operates on a hardware platform 304, which may be, for example, a hardware platform as illustrated in FIG. 13 below or elsewhere throughout this specification. Hardware platform 304 may provide, in general, a processor and a memory and an architecture for carrying out computing instructions.

Hardware platform 304 may have an operating system 308 and may include a small business agent 312. Small business agent 312 may be an agent installed by the small business to provide management of small business assets on the user device. Small business agent 312 may include, for example, a monitoring agent that monitors the device as well as an action agent that carries out certain actions. It is in the interest of the business and the user to ensure that small business agent 312 correctly manages business assets while protecting personal assets.

For example, user device 300 may include personal applications 316 and personal data 320. Personal data 320 are unlikely to have any relevance to the small business and are generally owned completely by the user. Personal applications 316 are often of a hybrid nature. For example, user device 300 may include an office suite that is useful for both personal business and for operating the small business. Thus, in some cases, personal applications 316 may be further subdivided into applications that are strictly personal and into hybrid applications that have both business and personal use.

User device 300 may also include business applications 324, which may be applications that are used strictly for business purposes and that have little to no relevancy for personal use. Business applications 324 are more likely, though not necessarily, owned exclusively by the small business. Business applications 324 may operate on business data 328, which may be data that are designated for use by the business and that have business implications. It may be beneficial to ensure that business data 328 and personal data 320 are not intermingled, and also to ensure that business data 328 are used only for business purposes. For example, it may be inappropriate for the small business user to access a customer list to send flyers for a personal bake sale. On the other hand, it may be inappropriate for the business to access personal data 320 that has no relevance to the business.

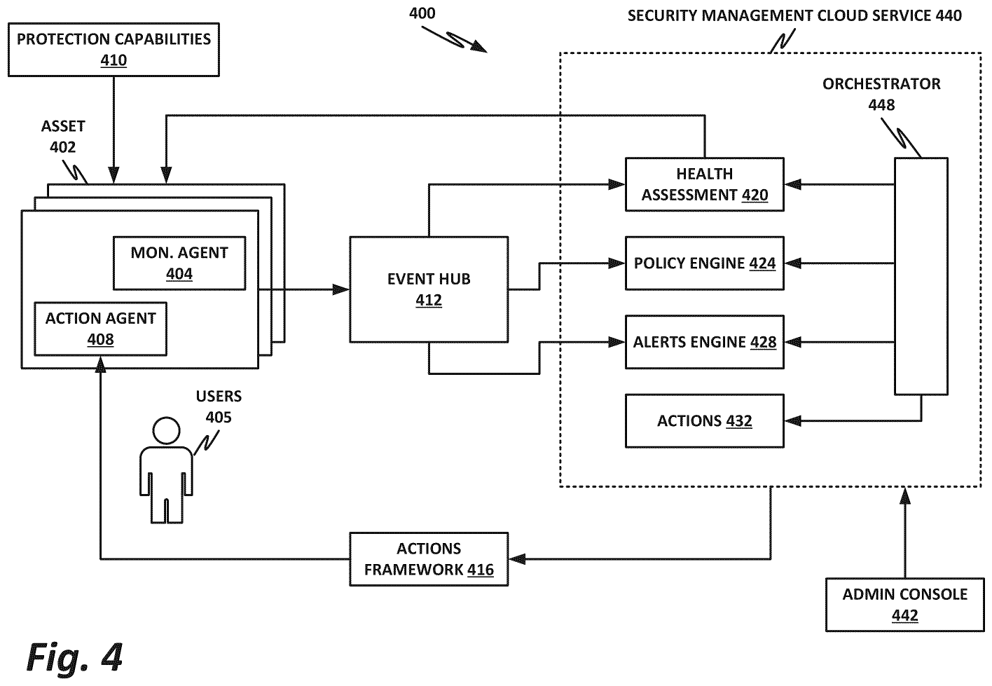

FIG. 4 is a block diagram illustration of selected elements of a risk assessment ecosystem 400. System 400 includes various functional blocks that are illustrated here according to the function that they provide, which may or may not be different from their structural physical embodiment. More particularly, the logical functions illustrated here are associated with certain operations that may be provided within a risk assessment ecosystem 400. These functions may be provided as standalone devices, such as single-purpose appliances. They may be provided as virtual machines, containers, microservices, or in any other logical configuration. In some cases, various functional blocks may be provided on the same physical device. Thus, the representation of risk assessment ecosystem 400 should be understood to be nonlimiting as to the division of labor between physical devices.

Ecosystem 400 provides a user centric view of the security of an organization. The system provides the protection state as a combined state of all the digital assets of the users that belong to the organization. Digital assets may include, by way of illustrative and nonlimiting example, devices, applications, identities (including email addresses and social media accounts), sensitive information, shared information, transactions, online accounts or services, or others. More comprehensively, additional assets are illustrated in FIG. 2 above.

Ecosystem 400 may include systems and methods to determine a user's risk profile based on an overall risk posture of all of the assets owned by or associated with the user. The risk posture may also include user behaviors, the user's role, privileges, and other factors.

Ecosystem 400 may be configured to present an overall security status as a simple health score that represents the overall health of all the users and assets in the organization. It may also provide a method that contextually defines security policies based on a user's risk profiles. The system may enforce those policies through security automation or other mechanisms.

Embodiments of ecosystem 400 may also provide a method to abstract the details of control and present a simple yet actionable construct that the small business owner can act on. This may be done without sacrificing the need for control over protection of digital assets.

Embodiments of ecosystem 400 encapsulate the complexity of the security posture into a health assessment. It may provide a policy framework for decision-making and execution by an automated action framework. Ecosystem 400 may also provide a user centric view of the security of an organization that views the security state as a combined state of all the digital assets owned by or associated with the user, including assets that belong to or that operate with the organization.

The user's risk profile may be based on overall risk posture of all the user's assets and user behaviors as they relate to security implications. The risk profile may also incorporate the user's roles and privileges. Ecosystem 400 may further provide automatic customization of the policy based on the user risk profile.

Embodiments of ecosystem 400 may recognize that many small business security models essentially follow the enterprise security paradigm. However, this may be overwhelming for small businesses where administrative experts and bandwidth may be limited. Thus, ecosystem 400 provides specific mechanisms to combine various data streams into a simplified view of the security status of the enterprise or small business. This provides a simplified and automated security management system. While this is particularly useful for small businesses, medium and large businesses may also benefit from the teachings of the present specification.

A discussion of security ecosystem 400 may begin with users 405. Ecosystem 400 may provide a security management framework that is primarily user centric. Users, in some cases, may be divided into groups for convenience. Users may also have specific roles, such as an admin role, employee, super admin, network administrator, security administrator, or others.

Users 405 may be associated with small business assets 402. Each asset 402 may have a well-defined ownership to a specific user. This ownership may represent a user who has primary responsibility for the asset. In some cases, more than one user may have access to an asset, and thus more than one user may be associated with the asset. For purposes of final responsibility, each asset may have an assigned owner who has overall responsibility for that asset. A user 405 may own multiple assets. In selected embodiments, each asset has a single ultimate owner. The term asset, as used herein, may encompass anything in the small business that needs to be tracked and/or protected.

Certain protection capabilities 410 may be mapped to individual assets 402. These capabilities may manage the detection, prevention, and remediation of threats to those individual assets. For example, protection capabilities 410 may include, by way of illustrative and nonlimiting example, antivirus, virtual private networks (VPN), online or web protection, social media protection, hardened password managers, online transaction protections, privacy monitors or managers, and others.

At least some assets 402 may have associated therewith a monitoring mechanism, which may be associated with a monitoring agent. Monitoring mechanisms for small business assets may be provided to monitor security events, provide security state and configuration, and provide streams to a small business protection cloud service. Thus, monitoring agent 404 may also provide a monitor streaming mechanism to stream security events to the cloud service. These events may be consumed by various subsystems, such as health assessment 420, policy engine 424, alerts framework 428, or others. These events may trigger certain business logic within the specific subsystems to provide specified outcomes.

A security management cloud service 440 may include various components to carry out its specified functions.

For example, a health assessment subsystem 420 may be provided. This subsystem represents the overall security posture of a small business by means of a health assessment score. This score may be representative of all protection vectors across all the assets of the organization that impact the security posture of the organization. A policy engine 424 may provide a policy framework. This may include a framework to define policies and evaluate policies for compliance with an enterprise-specified compliance regimen or policy.

An alerts engine 428 may receive alerts, such as streamed events from monitoring agent 404.

A security management orchestrator 448 may also be provided. Event hub 412 may aggregate event notifications and other notifications for consumption by orchestrator 448. Orchestrator 448 orchestrates the overall security management system. It may use an actions framework 432 to generate automated or semiautomated actions to improve the security posture of the small business. Actions 432 may be pushed out to an actions framework 416. It may also remediate any security threats, take preventive measures, provide recommendations, and provide alerts.

Security actions framework 416 may provide the mechanism to create, communicate, and automate security actions. An action agent 408 on asset 402 may then be provided to carry out the actions.

An administrative console 442 may be provided for use by an administrator of the security services provider. Admin console 442 may provide a user experience or user interface, including a status, reports, alerts, and actions. Admin console 442 provides a mechanism for an administrator of the security services provider to have an overall view of ecosystem 400 and to perform necessary actions.

Ecosystem 400 may achieve the simplicity that small businesses may prefer for managing business security. To this end, ecosystem 400 provides discovery and visibility of assets that matter to the small business. The system may also determine the security posture and determine what may improve the posture. Ecosystem 400 may also provide recommended actions 432 and action agent 408 that can carry out the actions.

Experience and expertise may be necessary to understand and interpret the telemetry data received from various assets 402. This expertise may determine who or what is vulnerable, why certain entities are vulnerable, the proper security settings for an enterprise, which product configurations are preferable in a particular context, and which user behaviors may be considered risky or dangerous. Understanding, interpreting, and correlating security events may be a complex task that requires high levels of expertise. Some of the complexity includes determining how to control and manage security. This management may include determining what to control, what to change, and when to change it. These decisions may rely on expertise that some small businesses lack.

Ecosystem 400 provides a user centric perspective rather than a device centric perspective. The system achieves user centricity via various mechanisms.

Ecosystem 400 may expand security management to security, privacy, and identity management. Thus, the threat surface of a user may go beyond an individual device. As a consequence, ecosystem 400 may provide an expansive view that goes beyond only devices and includes a plurality of assets that matter to the users and employees of a small business. Digital assets may include, by way of illustrative example:
Identities such as email address, federated IDs, and others
Other identities, such as tax IDs, driver's licenses, and other credentials
Social media profiles and posts
Online services, including financial and e-commerce
Other online accounts
Data, including local and cloud storage, emails, chats, blogs, and others
Devices, device environments, applications, and others
Network devices
Other communications including IM, chat, and others
Interactions, including interactions with online services and transactions.

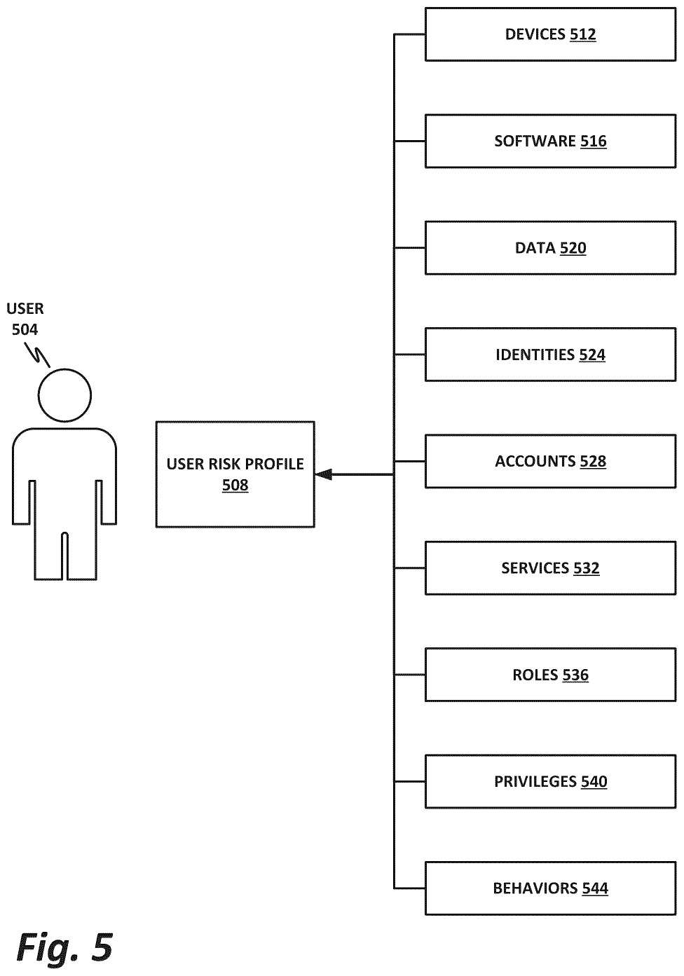

FIG. 5 illustrates another dimension of a risk assessment ecosystem, including a user risk profile 508. User risk profile 508 is another mechanism by which the risk assessment ecosystem may realize user centricity. User risk profile 508 may be associated with an individual user 504. User risk profile 508 may be computed based on the security state of various owned assets and user behaviors. It may also depend on the user's role and privileges and data that the user has access to. These may include employee data, sales data, privileges access, HR or sales systems, and social media assets. Thus, as illustrated in FIG. 5, user risk profile 508 may account for various factors such as devices 512, software 516, data 520, identities 524, accounts 528, services 532, roles 536, privileges 540, and behaviors 544, by way of illustrative and nonlimiting example.

User behavior may also play an important role in managing security and providing user centricity. Specific user behaviors that are high risk may be detrimental to the overall security of small business assets.

A user risk profile may be computed as a weighted sum of factors, including role sensitivity, asset ownership, and user behavior risk.

Role sensitivity, in one illustrative example, is a numeric score from 1 to 5. 5 is high where the role of the user needs to have access to more resources and data. A score of 1 is lower wherein the user has access to fewer resources and data. In an example, this number may be determined by having a human administrator familiar with the business rate the sensitivity of the user's role. Alternatively, the system may assign default values that can change over time.

Asset ownership may also be of value from 1 to 5. 5 is high and indicates that the user owns a large number of assets relative to the rest of the population of the small business. In one illustration, this may be expressed using bands of percentiles of assets owned of the organization, for example, with 5 representing the 90th percentile of asset ownership.

User behavior risk may also be a numeric value from 1 to 5, with 5 being the most high-risk behavior. Behavior risk may be constantly assessed and reassessed based on historical behaviors that are deemed risky. Behavior risk may be dependent on a specific security event encountered by a user. For example, if a user has a malware infection, visit malicious URLs, visit suspicious URLs, subscribes to low privacy services, or disregards warnings from security software, the user's behavior risk may be increased.

Mathematically:

UserRiskProfile=(w1*RoleSensitivity+w2*AssetOwnership+w3*UserBehaviorRisk)

In this formula, W1, W2, and W3 may be values between 0 and 1 and together may add up to 1. The weights themselves may be changed based on either administrator input or security expert input.

With user risk profiles assigned, users may be grouped based on a risk profile of the users. The risk factor may be propagated down to every asset owned by the user.

The risk assessment ecosystem provided herein recognizes that a business IT environment is complex even for a small business. Thus, the ecosystem may provide a system to simplify the representation of the overall security state of assets. These may be encapsulated into an overall health score.

The health score may be derived from a security state/configuration, specific security events, and/or behaviors of the stakeholders (i.e., users).

The health assessment score may be derived from various vectors. It may be expressed as a simple explainable score. Specific recommendations that can be implemented to improve the health score may also be provided to the small business. This simplifies the model for the small business administrator to understand the security state of all the business' assets.

In one example, the user health score may be represented by the following equation for each category:

$$\frac{{\sum }_{asset i = 1}^{n} \{ {v}_{i} \times [ {\sum }_{protection j = 1}^{m} ( {ws}_{ij} . {state}_{ij} ) ] \}}{{\sum }_{asset i = 1}^{n} \{ {v}_{i} \times [ {\sum }_{protection j = 1}^{m} ( {ws}_{ij} ) ] \}}$$

Within a category:
n is the total number of user assets with a list of M protections possible for asset I
vᵢ represents a notional value of asset I. This value can be changed by the administrator or may be learned gradually to reflect the changing monetary or security importance of the asset to the company. The higher the asset's value, the higher the importance that may be associated with the asset. These values may be periodically reassessed by the administrator based on changing access patterns. The value may correspond to multiple levels such as 1.0, 1.1, 1.3, 1.5. Alternatively, arbitrary values may be assigned.
wsᵢⱼ is the weight of protection vector J for asset I. These weights may be proportional to an impact on the user's security, privacy, identity, and trust. Illustrative values may include 100 for critical, 60 for high, and 30 for medium. These weights may be preconfigured or changed by an expert administrator. The vector weights may be automatically learned over time, set by the administrator based on the nature of the business, as gathered by an individual assessment questionnaire, or periodically assessed by the administrator.
stateᵢⱼ is 1 or 0 based on whether the specific protection J for an asset has been turned on or off. Each protection may be available as a feature and may be turned on by a user.

The numerator of the above equation is labeled acquired_score whereas the denominator is labeled max_score.

Regardless of the number of assets a user possesses or their values or the weights of a protection vector, the score for a category may be mathematically defined to be between 0 and 1. In other words, the score may not be an unbounded number and will not be a negative number.

Multiple category scores may be combined in the following way to generate an overall user health score.

$${Score}_{Total} = {M}_{f} \times {\sum }_{i = 1}^{n} {weight}_{i} \times \frac{{acquired\_score}_{i}}{{max\_score}_{i}}$$

In this case, weightᵢ (adjustable) corresponds to the weight across a category. Again, each weight may be a value between 0 and 1, and the weights may add up to 1.0. By way of illustration, security may have a weight of 0.6, identity may have a weight of 0.4, and privacy may have a weight of 0.1. All of the weights across the categories should add up to 1.0, i.e.:

$$1 = {\sum }_{i = 1}^{n} {weight}_{i}$$

Acquired score and max score are as described previously. The small business administrator may determine which of these categories is most important and may balance their weights.

M_{f} may be an internal “fudge” factor that may be always less than 1. This fudge factor may indicate the reality that protection is never perfect and thus the score may be adjusted to reflect this imperfection.

In some embodiments, user groups are an important aspect of small business security. Using the principles described above, it is possible to compute scores for arbitrary groups of users that are dynamically created by the administrator. A group may include assets that belong to individuals, individual user assets, and vectors. These may be combined into a group health score according to an equation that is similar to the user score:

$${Score}_{Group} = \frac{{\sum }_{asset i = 1}^{n} \{ {v}_{i} \times [ {\sum }_{protection j = 1}^{m} ( {ws}_{ij} . {state}_{ij} ) ] \}}{{\sum }_{asset i = 1}^{n} \{ {v}_{i} \times [ {\sum }_{protection j = 1}^{m} ( {ws}_{ij} ) ] \}}$$

A difference between the user health score and group health score is that, for the latter, all assets belonging to users in the group are scored. The terms in this equation are the same as those described previously.

As with individuals, the same with groups, category scores can be computed across security, privacy, and identity. The same constraints about the weights are applicable to the group score.

An organization health score may be similarly calculated across all assets of the organization. An organization-wide category score can also be created.

Thus, health scores can be computed across multiple levels. They may be computed across user assets owned by individual employees, a group of employees, and for the overall organization. Beyond the organization, the score of a group of companies that have similar security profiles, business types, or other classifications like regional location, may also be computed. These scores may provide a holistic score across all dimensions or may be a specific score for security, identity, and/or privacy.

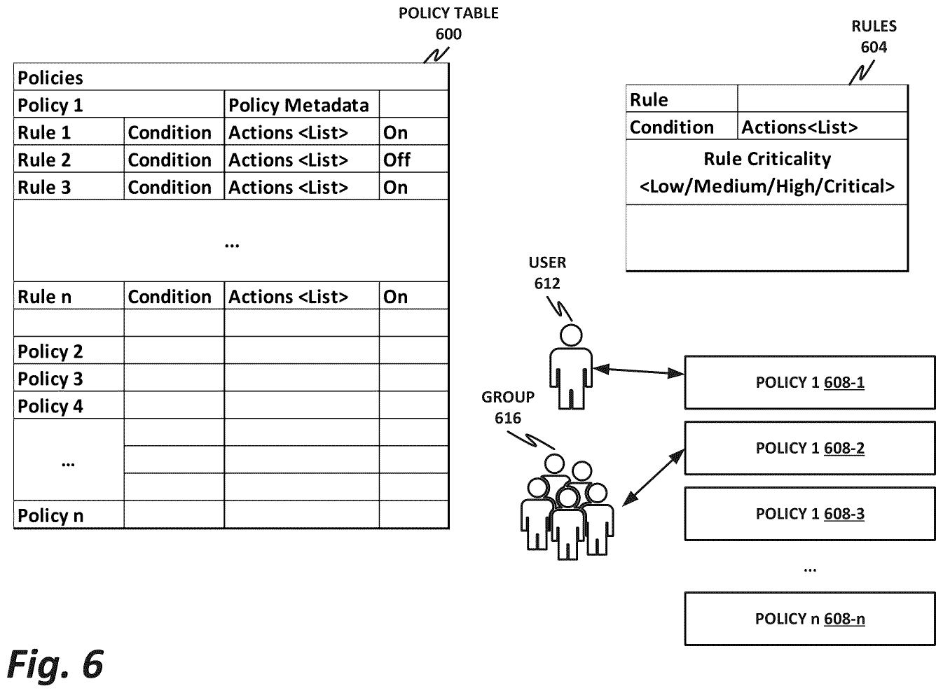

FIG. 6 is a block diagram representation of selected aspects of security state management. Security state management may be encapsulated into a policy that dictates the compliance required to keep assets secure. A policy may consist of a set of rules. Each rule may include an expected state that triggers the rule, a designation of what constitutes a violation and an optional severity of the violation, and a specification of actions to take to make an asset compliant with the policy.

A policy engine may process all security events to assess the compliance to the applied policies and automatically generate required actions to be executed to make the asset compliant to the policy.

A policy table 600 is provided by way of illustration. This policy table should be understood to be an illustrative and nonlimiting example of how a policy table may be structured. In this example, policy table 600 includes an array of policies labeled policy 1 through policy N. Each policy may include a group of rules labeled rule 1 through rule N. These rules are active for the policy or may optionally be inactivated by turning them off, as in the rightmost column. Each rule may also include a list of actions to be taken if a condition is true. A rule may also include a condition based on a specific state of a user or an asset. When the condition is found to be true, a list of actions may be applied and may be performed by an action agent on the asset. Some rules may also have an optional criticality value. As illustrated in rule 604, rules may have an optional criticality value. The criticality value may signify the importance of the rule to the overall security state of the asset and/or user. This may signify the importance of the rule to the overall security state of the asset and/or the user.

A user 612 or a group of users 616 may be assigned to various policies 608. For example, user 612 may be assigned policy 1 608-1, group 616 may be assigned to policy 2 608-2. Additional policies, such as policy 3 608-3 through policy N 608-N may be assigned to various users and/or groups of users.

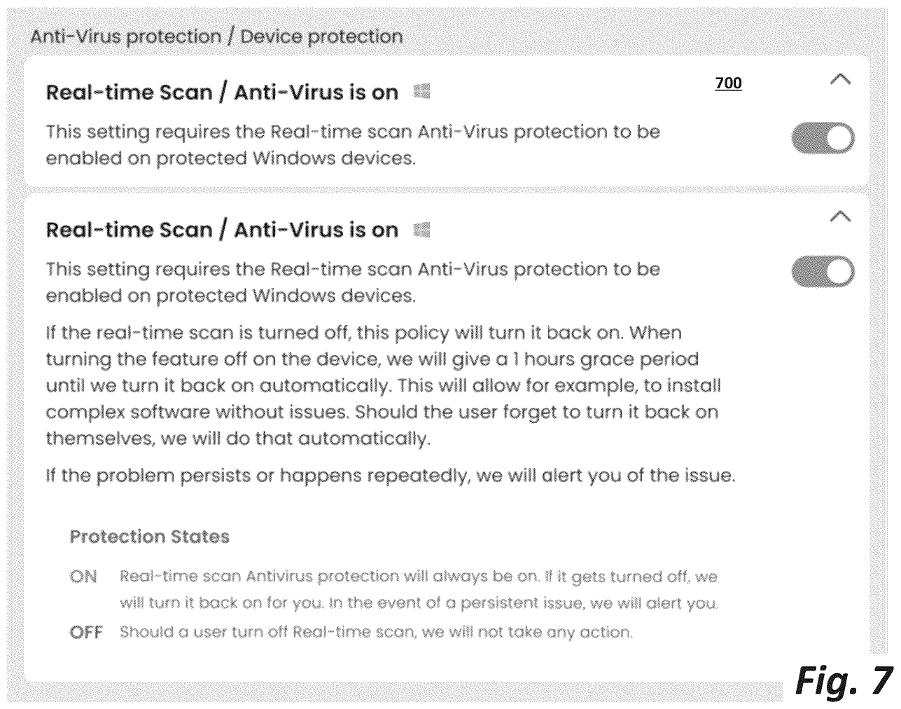

FIG. 7 is a block diagram illustration of an illustrative user interface elements 700. UI elements 700 is a dashboard that may be displayed to a user to indicate a device protection status. In this case, the user has enabled real-time scan and antivirus. The interface also indicates that, if real-time scan is turned off, a policy applicable to the small business will turn it back on. In this case, a user is given a one-hour grace to perform any necessary work before real-time protection is turned back on. This may be useful, for example, in the case of complex software that requires antivirus protection to be disabled before it can be installed. Good practice is that the user would turn antivirus off temporarily to install such software and then turn it back on. However, if the user forgets, the policy indicates that real-time scanning in antivirus should be turned back on automatically to protect the user and the business.

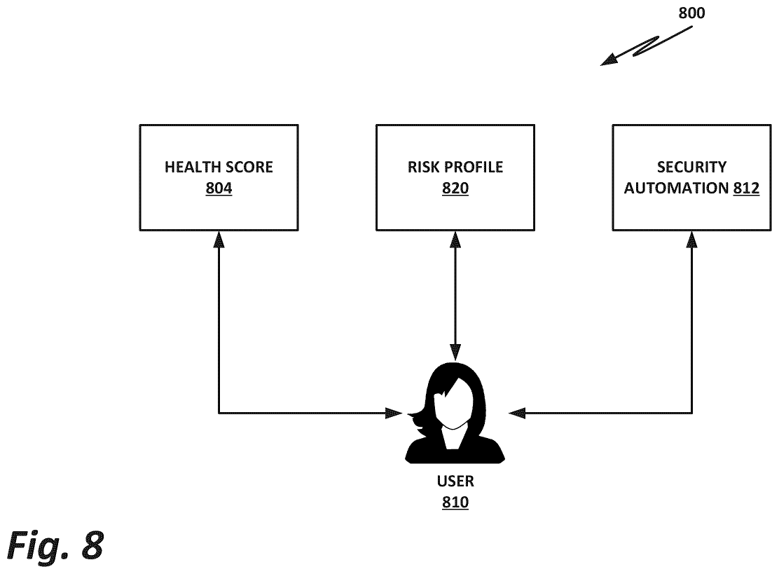

FIG. 8 is a block diagram illustration of selected elements of a user protection ecosystem. User protection ecosystem 800 operates with a user 810 and provides both a health score 804 and security automation 812, such as the security automation illustrated in the previous FIG. 7.

A small business administrator may customize a policy automatically based on a risk profile. Users, such as user 810, may be divided into risk groups with automated policy customizations for each risk group. Each user or group may be assigned a policy as applicable to the whole company or a specific policy for different groups. A baseline policy may be customized to a specific user based on the user's risk profile 820.

Mechanisms to customize policy may be available. A policy may include a set of rules with some rules active and others optionally inactive. The mechanism to customize may provide a user interface or other elements to the small business security administrator. This mechanism may automatically make certain rules active for certain users based on risk profile 820 and the criticality of the rule.

For users with high-risk profiles, even rules with lower criticality may be made active. For example, the following table illustrates how a policy may be customized for a specific user based on the user's risk profile 820. In this table, “default” implies that the rule has some state as in the base policy. For example, if the rule is “active” in the base policy, it remains active for the user. If the rule is off in the base profile, it may remain off for this user. “Active” in the table implies that the default state of the rule is overridden for this user. In this case, the rule is always active for the user, regardless of the default state.

Rule Criticality

| | Low | Medium | High | Critical |
|---|---|---|---|---|
| User Risk Profile - 1 | Default | Default | Default | Active |
| User Risk Profile - 2 | Default | Default | Default | Active |
| User Risk Profile - 3 | Default | Default | Active | Active |
| User Risk Profile - 4 | Default | Active | Active | Active |
| User Risk Profile - 5 | Default | Active | Active | Active |

The outcome of executing a policy may include a list of actions that are automatically executed to ensure that the security state of all assets are compliant to the designated policy. Illustrative classes of actions may include:
Inform—information to a specific user or group or an admin
Advise—security advised three specific user group or administrator
Inform and act—inform the admin and enforce. Since the action is critical for the security posture and/or the platform, such automation may be appropriate
Seek permission and act—ask the admin for consent or permission before acting as above
Act and inform—the action is sufficiently critical that it is automated, and the admin is informed only after the action is taken. This may be appropriate for a case where the system cannot wait for the admin to see the alert and act on it.

Actions may be prioritized based on the context, target user risk profile, and/or expected outcome. For example, outcomes may include health score improvement, preventive measures, or user education. Examples of different actions and classifications include:

| Action | Security Impact | Action type classification |
|---|---|---|
| Enable On Access | Critical | Act and inform |
| Malware scan | | |
| Enable Wi-Fi | Medium | Advise |
| security | | |
| Update OS | Medium | Inform and Act |
| Use VPN | Medium | Advise |

A dispatch framework may be provided in software to send the actions to users and assets. The dispatch framework may decide which actions are to be sent to which destinations and when. These decisions may depend on the priority of the actions and the type of actions being taken. For example, an informed type action may be targeted to a user and sent to a device where the user is active. Alternatively, the action may be sent to the device at a time when the user is most likely to be active or likely to respond. In the case of an act and informed type action, the action may be sent immediately to the asset that the action is targeted to, and the asset's action agent is expected to complete the action before information is sent to the user.

The system and methods provided here provide necessary monitoring, visibility, manageability, control, and end-to-end automation for small businesses. These may help the small business to take remedial and preventive actions to secure the IT infrastructure. Small businesses may lack the experts on hand to understand and manage complexity. Therefore, this system provides methods to abstract the controls into a health score, alerts, and automation through a simple console application. This may be provided in a web portal. In this system, the users understand security risks at a glance and may act on remediation with informed clicks. This simplicity is provided even though the system employs complex methods for monitoring and remediation.

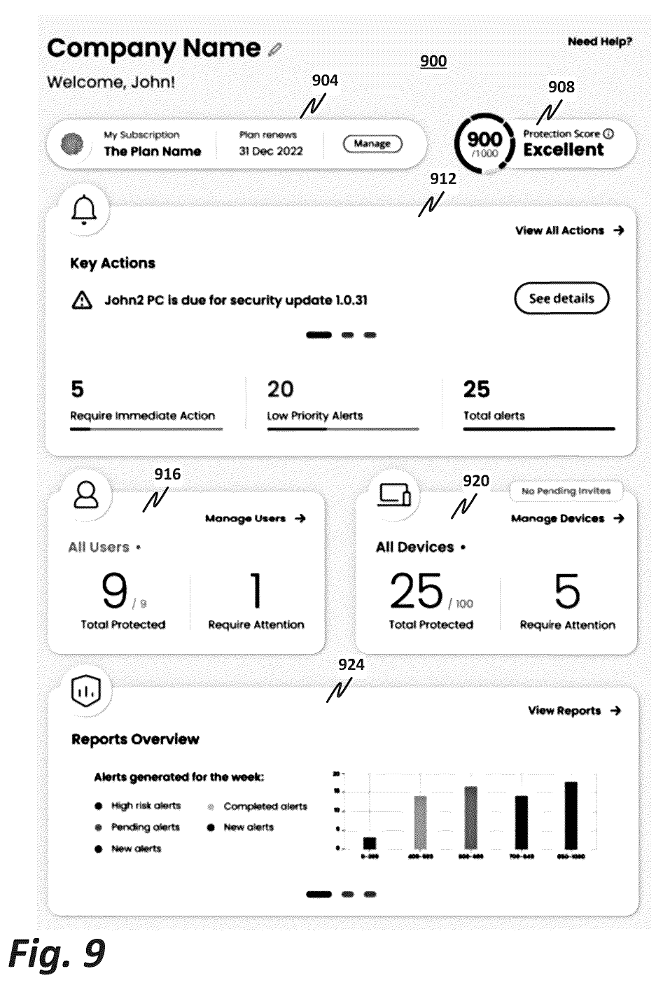

FIGS. 9, 10 and 11 provide illustrative UI elements that may be provided in a security ecosystem.

FIG. 9 illustrates a dashboard 900 that is provided to a user named John. John may be a small business owner or a person in charge of security for a small business. In this case, the dashboard provides a plan status 904 that informs John of the current plan and when it will be renewed. An enterprise health score 908 provides an overall health score for the enterprise. In this case, the enterprise is scored 900 out of 1,000 points. This may be scaled based on the raw health score to provide a useful metric for the small business. In this case, the health score also includes an enumerated score category such as “excellent.” Color coding may also be used, such as green for excellent, yellow for fair, orange for poor, or red for critically low.

A key actions dashboard 912 may indicate key actions that may need to be taken. For example, John may have a second PC called John 2 PC that is due for a security update to version 1.0.31 of a particular piece of software. User John can click on the see details button to see additional details about this alert. John is also informed that there are five actions that require immediate action and 20 low priority alerts. This provides 25 total alerts. User John can click on the button, view all actions to see all available actions and what needs to happen for each one.

A user dashboard 916 indicates that there are nine managed users for this enterprise and, of those, one requires attention.

A device dashboard 920 indicates that there are 25 total devices for the enterprise with five that require attention.

Finally, a reports overview 924 may provide graphs and reports that may provide easily digestible information for user John.

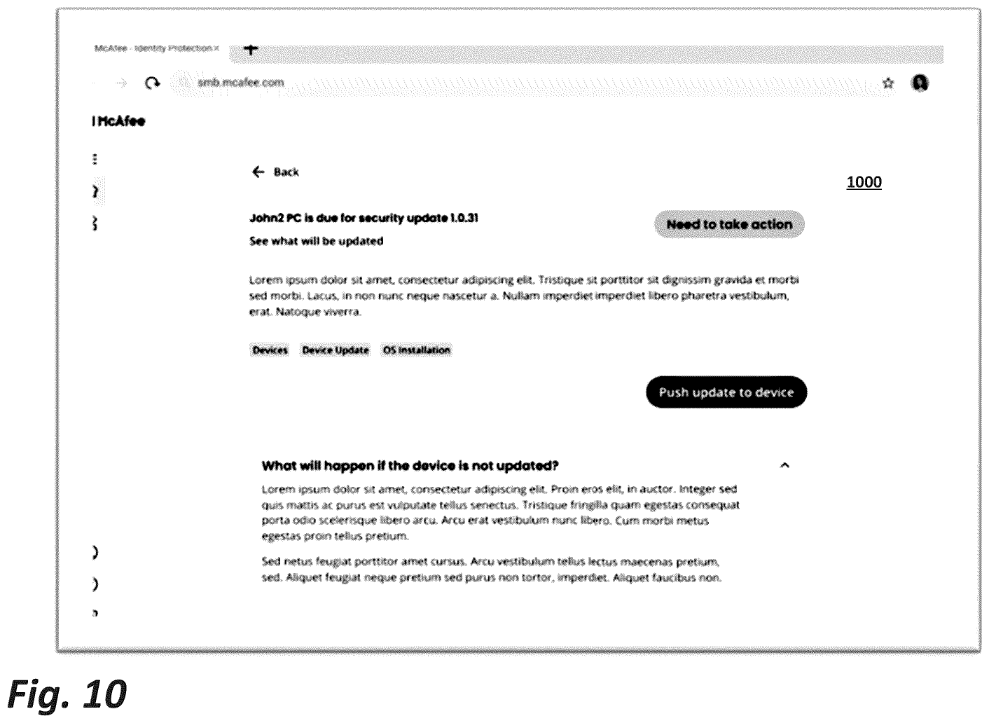

FIG. 10 is a block diagram illustration of a UI element 1000, which provides a detail view, such as may be reached when user John clicks on the button see details on key actions dashboard 912.

In this case, John is provided with details for the security notification that John 2 PC is due for a security update to 1.0.31. The dashboard detail view may inform John of what updates will be applied and what will take place if John uses the button to push the update to the device as illustrated. This view may also include a box to tell John what will happen if the device is not updated. This may warn John of security implications of not taking the action. In some cases, John may have a cogent reason for not taking the action and thus may elect not to push the update to the device. This detail view will help John to make an informed decision about whether to go ahead and push the update or to stay on the current version and may help John understand the risks and rewards of each action.

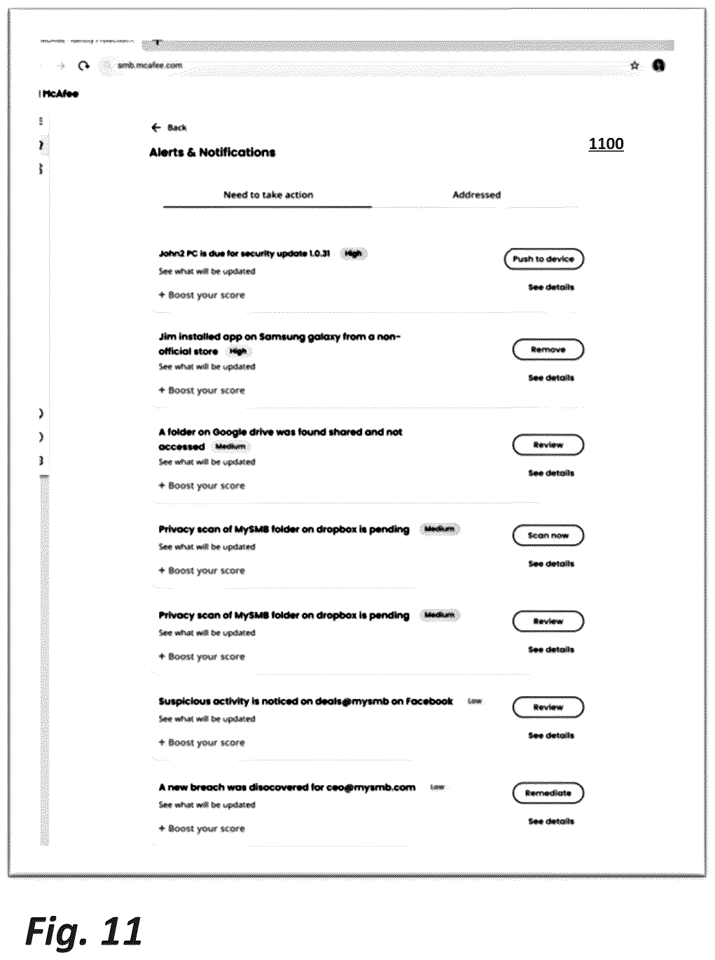

FIG. 11 is a UI element 1100 that illustrates a view that user John might see if he clicks on view all actions in key actions dashboard 912. In this case, John is given a list of available alerts and notifications. Each individual item may have a short description such as “John 2 PC is due for security update 1.0.31” along with an indication of the severity, which in this case is high. The dashboard may also provide a simple button to push the update to the device. Another alert is “Jim installed app on Samsung Galaxy from a non-official store”. This has a high security alert as well. In this case, user John has a simple button that can be used to remove the app from Jim's Samsung Galaxy device. This would remotely instruct the action agent on Jim's Samsung Galaxy device to remove the unapproved application.

A medium level notification is “a folder on Google Drive was found shared and not accessed.” In this case, user Jim has a simple button to review the folder and available options.

A medium security risk also includes “Privacy scan of MySMB Folder on Dropbox is pending.” In this case, a scan is scheduled but has not yet been carried out. In that case, a simple button may allow user John to “scan now.”

A low-risk security notification is “suspicious activity is noticed on deals@MySMB on Facebook.” In this case, user John may have a simple button to review the alert and actions are available.

Another low severity notification is “a new breach was discovered for ceo@MySMB.com.” In this case, John has a simple remediate button which will carry out remedial action to remediate the breach.

In each instance, the user also has an interface to “see details” so that the user can see additional details about the security notice and also has an indication that addressing the issue will “boost your score.” Finally, the user may also have a button that indicates “see what will be updated.” This may provide an interface where the user can see which specific actions will be taken to remediate the security alert.

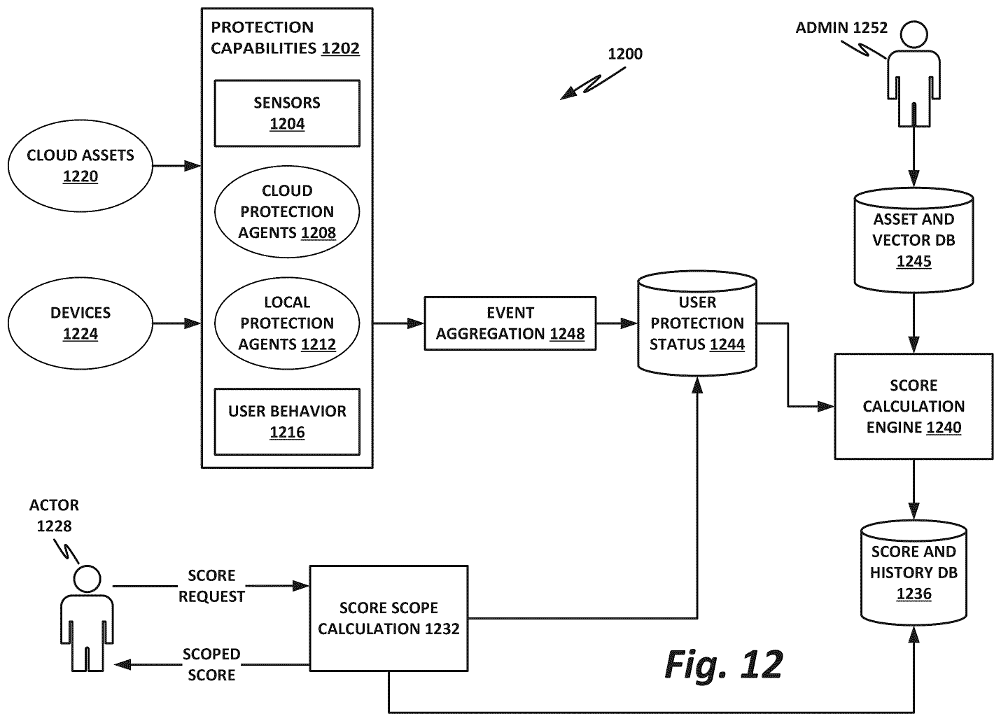

FIG. 12 is a block diagram representation of selected elements of a system 1200. System 1200 represents an additional embodiment of the small business ecosystem illustrated herein. System 1200 provides an additional embodiment wherein certain adjustments and modifications to the computation of risk assessment scores are made. System 1200 may be desirable because the complexity of protection may rise with the number of employees working from home or using a variety of personal devices for business purposes. As above, the small business may need to protect not just devices, but also any business assets including business employee accounts and business data shared on third-party platforms. Thus, a small business security solution may incorporate both efficient and effective protections to help ease administration from an end-user perspective.

This embodiment may equip the small business administrator with a meter to gauge organizational security health. With this meter, the administrator can quickly visualize how healthy the organization's protection is. This metric may be based, in part, on the elements of a comprehensive business threat surface. It may also include a characterization of significant business threat vectors. The metric may also be aided by defining mechanisms to assess the personal protection threat state of users and devices. The metric may also be aided by defining a method to quantify protection across the entire personal protection threat surface.

System 1200 may help to enable small business administrators to have a ready and visible idea of the organization's protection health, thus requiring action only when the score dips below a certain level.

As users increasingly BYOD and use their own devices for work, along with shared business resources, it may be desirable to offer personal and business scores within a single company. When the score is personal, the issue of privacy may be of higher importance. Thus, it may be desirable to offer a score that considers both role and privacy aspects for users individually and across the business.

In some cases, protection of personal data and personal devices may be offered by the small business employer to employees as a value-added extra. This may represent a fringe benefit associated with working for the business. Thus, while providing a nonbusiness user privacy health score may not impact business operations directly, it may be valuable for employee retention and recruitment and employee satisfaction.

Adjustments to the health score ecosystem may include an ability for an administrator to personalize the organization's score, such as by changing asset values or specific vector weights that are unique to that organization. Asset values and vector weights may initially be assigned by the security services administrator, but it may be valuable for the small business administrator to make adjustments that are specific to the enterprise. An additional adjustment may include allowing multiple views of the business score within the same organization. These may include an overall organization-specific business score, as well as a group score and a privacy and role-scoped individual user score.

In some of the preceding embodiments, the value of assets may be determined by a security solutions provider, such as McAfee, Inc. These asset values may be designated according to asset classes. This and other embodiments further provide an ability for an administrator to change individual asset values based on their importance to the individual company.

In preceding embodiments, the weights of individual vectors may be determined to be high, medium, or low based on impact. This and other embodiments may enable an administrator to change weights based on the expertise of an administrator. The administrator may change even individual vector weights per organizational importance. It may also be possible to nudge a user towards a higher vector value depending on specific malware campaigns which can later be readjusted as necessary.

This embodiment may also provide an automatic mode wherein learning from admin and user behavior may lead to suggestions for value and weight changes for a user, group, or organization.

Preceding embodiments may also include category values determined by the security solutions provider. This and other embodiments may also add the possibility of an administrator specifying category values for an organization. For example, company A may give the security category a higher value, such as from 0.6 to 0.8, while reducing the category values for identity (e.g., 0.3 to 0.15) or privacy (e.g., 0.1 to 0.05).

This embodiment may also provide the ability to score categories (e.g., good, fair, excellent) to different score levels for specific users. For one user, it might be acceptable to have a “good” security score, while other users may need to have a higher category score to be acceptable to the organization. For example, an intern with limited access to business-critical data and proprietary data, and with limited scope of duties, may have a fair security posture, and this may be deemed acceptable for the organization. However, the small business CEO or CFO may need to have an excellent security posture to meet policy for the small business.

User scores may also involve individual user accounts that are shared between personal and business users. In this embodiment, the administrator may get a business score and view only alerts that need action. It may also be possible for a user score to not be shared with the administrator. This may lead to a score that maintains individual user privacy while ensuring that the user remains security compliant. Thus, in some cases, the user may have a personal security posture as well as a business security posture. For example, as illustrated in FIG. 3, a user device 300 may include both personal data 320 and business data 328. User device 300 may also include personal applications 316 and business applications 324. Small business agent 312 may provide a business score to the user based on the user's security posture as it relates to business data 328 and business applications 324. This score may be shared with the business security administrator as it impacts the business directly. However, as a value-added extra, small business agent 312 may also provide an individual score for personal applications 316 and personal data 320. Optionally, this personal user score may score privacy higher than security relative to the business security score. The individual user may be more concerned about preserving privacy. This personal security score may not be shared with the business administrator but may be displayed to the individual user on a personal dashboard with attendant recommendations for maintaining personal security. This may be a value-added extra that helps the users maintain both business and personal security and provides security protection, including a degree of privacy for the individual from the business.

This embodiment provides advantages including combining non-device asset classes with devices for a score. This solution also provides the ability to dynamically change or assess asset value or vector values. Further advantageously, this system may provide a twofold score. The score includes an individual user in a business with a mix of personal and shared assets, as well as a protection score across entire business. The system may also advantageously provide privacy and scope-compliant scores.

In this embodiment, two different scores may be displayed for users while maintaining individual user privacy with respect to the business or enterprise. Thus, for example, individual users may not be shown the entire business score because that may be outside the scope of their responsibilities. On the other hand, business security administrators may not be shown individual scores because this may violate user privacy.

This embodiment also allows an organization to set its own importance for assets, categories, and protection vectors as necessary. This may result in an organization-specific protection score that is unique to that particular enterprise. This may give the administrator more control.

This embodiment makes it possible to offer a combined personal and business protection solution. Personal protection can be provided as a perk or value-added extra, with scores and assets being solely personal. Business protection may be considered for shared or business assets.

A business IT environment may be complex even for a small business. This embodiment simplifies a representation of the overall security state of all assets that may be encapsulated into a health score for either the business or an individual user. As illustrated in FIG. 12, the health score may be derived from a security state or configuration that includes asset values and vector values. It may also include specific security events and behaviors of the stakeholders.

In this example, the individual user may be actor 1228, who may be interested in a score scope calculation 1232. Thus, actor 1228 may request, via a device such as a mobile device, tablet, laptop, desktop, or other computer, a score scope calculation 1232. This score request may result in a scope score provided to actor 1228. This score may include a personal score that is not shared with business administrator 1252 and that is only displayed to actor 1228. However, the mobile device may also calculate a business scope score that is shared with admin 1252. Admin 1252 may have access to an asset and vector database 1245, which may allow admin 1252 to adjust certain attributes of the calculation according to the needs of a specific business. These are provided to a score calculation engine 1240, which performs the actual computation. Score calculation engine 1240 may store business scores in a score and history database 1236. However, the individual or personal user score for actor 1228 may be stored locally on the user's device and may not be exported to an enterprise scope score and history database 1236.

The score may include protection capabilities 1202 for cloud assets 1220 and devices 1224. Protection capabilities 1202 may include sensors 1204, cloud protection agents 1208, local protection agents 1212, and user behaviors 1216. As in prior embodiments, these protection factors may result in protection events or triggers, which may be aggregated via event aggregation 1248. Event aggregation 1248 may be an input to a user protection status 1244, which may also consider the personal and/or business score of actor 1228. These inputs may ultimately be used to provide score calculation engine 1240.

In this embodiment, the user health score may be as calculated above, including the same variables as described above.

$$\frac{{\sum }_{asset i = 1}^{n} \{ {v}_{i} \times [ {\sum }_{protection j = 1}^{m} ( {ws}_{ij} . {state}_{ij} ) ] \}}{{\sum }_{asset i = 1}^{n} \{ {v}_{i} \times [ {\sum }_{protection j = 1}^{m} ( {ws}_{ij} ) ] \}}$$

One difference in this embodiment is that individual vector weights wsᵢⱼ and notional asset values vᵢ may optionally be controlled by an administrator of the small business. The assets considered for a user may also include a mix of private, shared, and business-allocated assets. For a user individual or personal privacy score, all of these assets may be considered. For a business score, only business or business-adjacent assets may be considered. Regardless of the number of assets a user possesses or their values of weights of a protection vector, the score for a category may be mathematically defined to be between 0 and 1 as before. As before, the value will not be an unbounded number and will not be negative.

Similarly, a total score may be calculated as above.

$${Score}_{Total} = {M}_{f} \times {\sum }_{i = 1}^{n} {weight}_{i} \times \frac{{acquired\_score}_{i}}{{max\_score}_{i}}$$

A modification in this embodiment may include that the category weightᵢ may be changed by the administrator.

Furthermore, a group score may be calculated as above.

$${Score}_{Group} = \frac{{\sum }_{asset i = 1}^{n} \{ {v}_{i} \times [ {\sum }_{protection j = 1}^{m} ( {ws}_{ij} . {state}_{ij} ) ] \}}{{\sum }_{asset i = 1}^{n} \{ {v}_{i} \times [ {\sum }_{protection j = 1}^{m} ( {ws}_{ij} ) ] \}}$$

In this embodiment, the assets considered for a user may include a mix of private, shared, and business-allocated assets. The business score may measure protection across shared and business-allocated assets. However, in that case, the assets may not be deemed private by the user. If assets are deemed private, then those private assets may be excluded from the group score.

FIG. 13 is a block diagram of selected elements of a business ecosystem 1300, which may be for any enterprise of any size, and is illustrated here in the context of a small business. Business ecosystem 1300 has a plurality of assets in both a business domain 1304 and a cloud domain 1330. Within the cloud domain, this business may possess software-as-a-service (SaaS) apps and cloud content 1334, employee and business accounts 1338, and employee and business identity or credentials 1334. Although these assets may be hosted in the cloud, the business and/or its employees may have property rights or interests in these assets.

Within business domain 1304, the business has users 1316, data 1312, and devices 1308. As a subset of business domain 1304, there is an employee domain 1310. Employee domain 1310 may include a number of users/employees 1320, online user experience 1318, and user privacy protections 1324. Any of these elements within business ecosystem 1300 may be illustrative examples of assets 200 (FIG. 2).

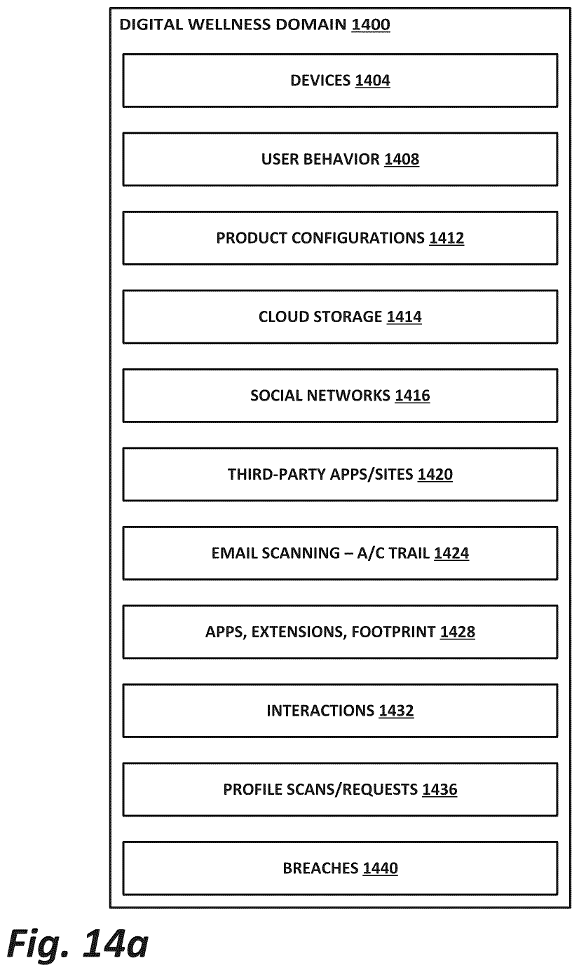

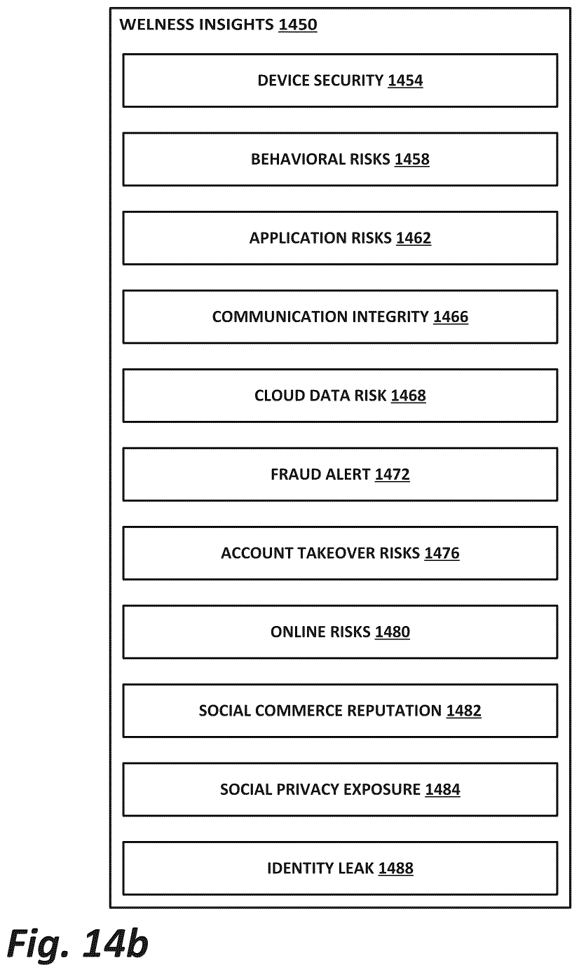

FIGS. 14a and 14b are block diagram illustrations of a digital wellness domain 1400 and wellness insights 1450. Digital wellness domain 1400 includes a number of elements that may be considered assets or attributes of a small business and its users, while wellness insights 1450 represent information or data that may be useful in analyzing the security and privacy stature of a small business.

Digital wellness domain 1400 includes, by way of illustrative example, devices 1404, user behavior 1408, product configurations 1412, cloud storage 1414, social networks 1416, third-party apps or websites 1420, email scanning (with account trail) 1424, app extensions and footprints 1428, interactions 1432, profile scans and request 1436, and breaches 1440.

Turning to FIG. 14b, wellness insights 1450 may include, by way of illustrative and nonlimiting example, device security 1454, behavioral risks 1458, application risks 1462, communication integrity 1466, cloud data risks 1468, fraud alerts 1472, account takeover risks 1476, online risks 1480, social commerce reputation 1482, social privacy exposure 1484, and identity leaks 1488.

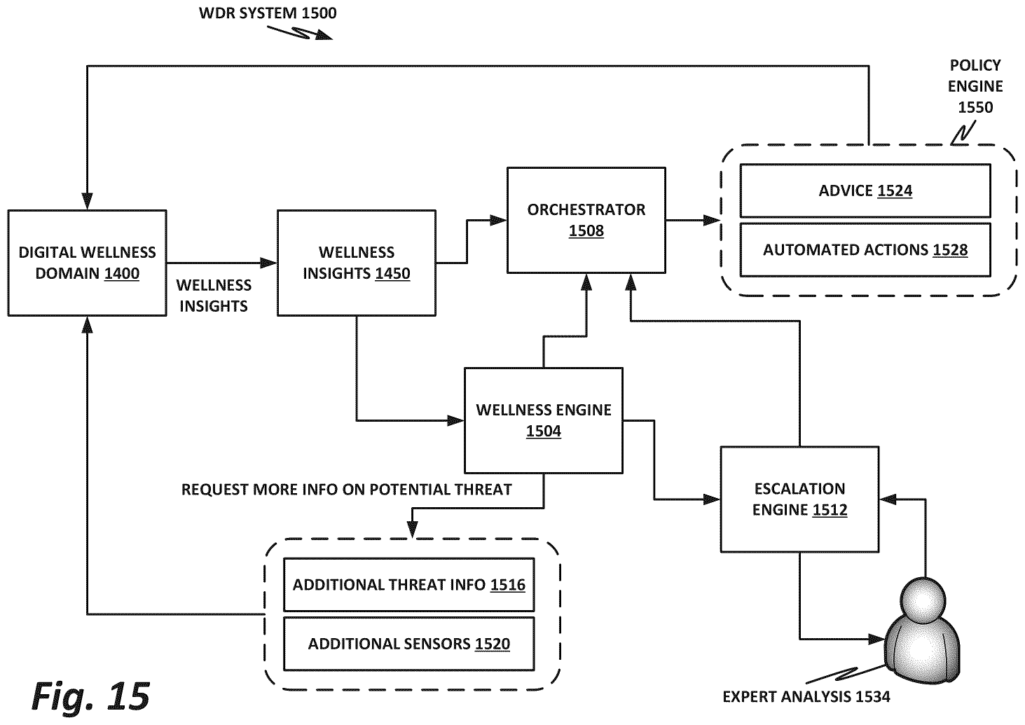

FIG. 15 is a block diagram illustration of selected elements of a small business WDR ecosystem 1500. SB wellness ecosystem 1500 may include digital wellness domain 1400 and wellness insights 1450 from FIG. 14.

Digital wellness domain 1400 may include digital entities, ownerships, accounts, and activities of the small business across its employees and devices. Within ecosystem 1500, collection agents (e.g., sensors, monitors, or software running on individual devices) may collect events and traces from digital wellness domain 1400.

Sensory devices may be built into devices to monitor device state, OS state, security products, device configurations, and other parameters. A traditional EDR may collect extensive information, and the volume of data may be overwhelming for small and medium-size businesses. A WDR system of the present specification might limit the data to an abstraction level that is manageable for a small business owner. The WDR may also collect events such as security tool configuration changes, so that actions taken by the WDR or the expert can be preventive, rather than merely reactive to events.

Sensors may also be built for applications, browser extensions, and utilities. These sensors may convey changes in the application state as events to a wellness insights engine 1450. Events may include, by way of illustrative and nonlimiting example, changes to list of applications, new installations, permissions granted, permissions changed, updates, notifications, messages, or others.

The system may also include sensors for user-owned assets on the Internet, including cloud storage, federated logins, applications and sites that use these federated logins, data exchanges through online interactions, email accounts, accounts created for the small business, privacy exposure on websites, PII or other identity information, and recorded data breaches.

Sensory data may be collected by agents employing various techniques, such as monitoring, log collection, APIs provided by services, scraping, and others. The specific technique employed may be dependent on the requirements and restrictions of the monitored digital assets.

A wellness insights engine 1450 may support many methods that analyze data and drive insights and patterns across security, privacy, and identity. While the subsystem may be useful to human experts, it may also include prebuilt methods to provide answers to manually-selected questions regarding the digital wellness of the small business environment across multiple assets. The system may also include cross domain analysis methods that yield deeper insights and impacts.

Analysis methods may include, by way of illustrative and nonlimiting example:
a. Extent of privacy exposure across sites where the user has accounts.
b. Application lifecycle and usage patterns across multiple devices by the same user.
c. Importance and priority to remediate a set of breached accounts, based for example on derived information shared with those accounts.
d. Impact of password breaches or suspected attempts to take over user accounts.
e. Risk to small business security based on content shared on social media accounts of employees.
f. Anomaly detection of user or company accounts that predict potential takeover risk scores.

A wellness engine 1504 may digest wellness insights 1450, and as necessary, may request additional information on potential threats. This may include collecting additional threat information 1516, and requesting information from additional sensors 1520.

Wellness engine 1504 may also interact with an escalation engine 1512, which may automatically identify wellness events that require further expert analysis. These events may be elevated to an expert 1534, such as a human expert or an AI expert, which can provide additional analysis and information. In some embodiments, small businesses need not employ a dedicated human expert 1534, but rather a service provider may provide a pool of experts to share across multiple small businesses. Small businesses may then query experts from the pool as necessary.

Orchestrator 1508 may consume information from wellness insights 1450, wellness engine 1504, and results of escalation engine 1512, and may provide a digital dashboard that an SB security administrator can use to easily view events and information. Orchestrator 1508 may drive a policy engine 1550, which in addition to recommending policy, may effect policy by providing advice 1524 and automated actions 1528.

Advice and actions from policy engine 1550 may be provided back to digital wellness domain 1400, as may threat information 1516 and sensor information 1520.

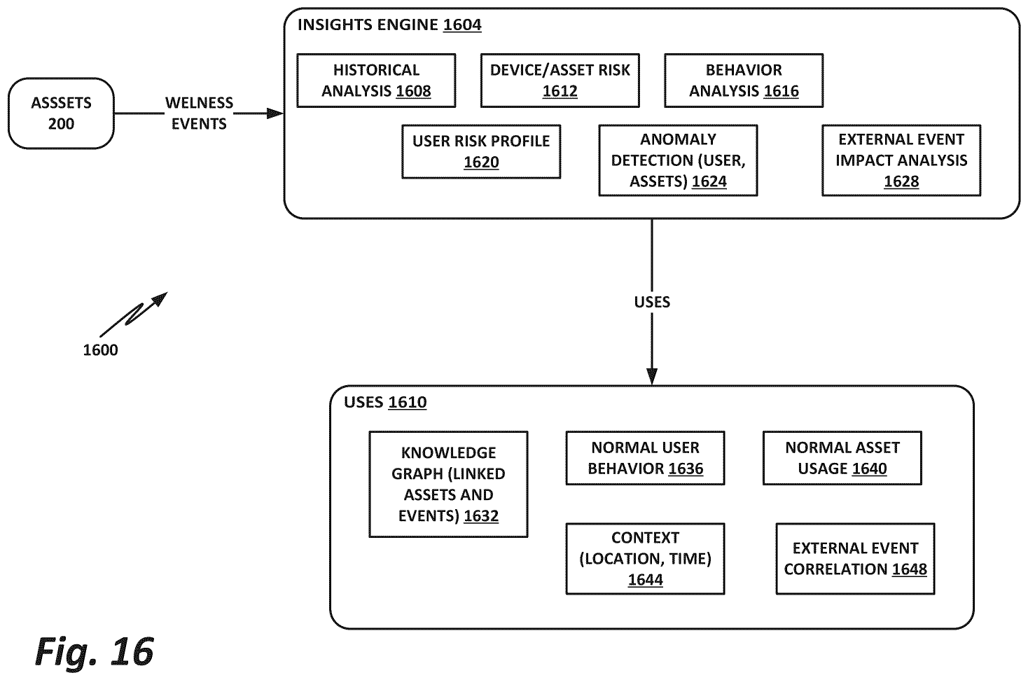

FIG. 16 is a block diagram illustration of additional aspects of a small business wellness ecosystem 1600. In this example, an insights engine 1604 provides insights, such as wellness insights 1450 of FIG. 14. Wellness insights 1450 may be based on SB assets 200, which provide wellness events.

Insights engine 1604 may include modules to derive various insights, such as those illustrated in 1450 (FIG. 14b) or elsewhere throughout this specification. Insights engine 1604 may then of assign device or asset risk profiles 1612 or user risk profiles 1620 based on those insights.

Insights engine 1604 may use baseline information as a knowledge base to derive insights. The baseline may be built over time, and may occasionally be curated.

A knowledge base for insights engine 1604 may include normal behavior of assets and users. Insights engine 1604 may store typical access patterns of accounts, such as time and location of access, types of activities performed on the assets, typical domains and categories of websites visited by a user or device, account activities (reads, writes, deletes, shares, etc.), and others.

Insights engine 1604 may derive an activity context related to normalcy. This may be illustrated as <Activity Context: Normalcy>. Activity context in one example is a tuple of activity and the context in which the activity happens. Activity may include one or more user actions, such as share, copy, access, login, delete, modify, or other actions, with appropriate attributes. In an illustrative example, the activity “share” may include attributes such as share, shared object descriptor, the scope of sharing, and others. This may be represented as a tuple in the form of Activity:<sharer, what is shared, sharee, scope>. Each activity may have an appropriate set of attributes.

Normalcy may include a measure of how likely an activity context is to happen. In an illustrative example, normalcy may have a range of 1 to 5, with 5 being highly expected behavior, and 1 being highly unexpected behavior.

An example for a storage device may include the following:

Activity Context<share, [dropbox.com], document, private>: Normalcy<2>
Activity Context<share, [photos.google.com], pic, any>: Normalcy<5>

For a device:

Activity Context<copy, [MyPC1], document, [USB]>: Normalcy<2>
Activity Context<login, [MyPC2], any_time>: Normalcy<2>

For a bank account:

Activity Context<access, [bofa.com], access_source: new device, access_location: new location>Normalcy<2>
Activity Context<Transact, [wellsfargo.com], access_source: [MyPC1], access_location:[User_Home]>: Normalcy<5>

To derive activity tuples, insights engine 1604 may use historical analysis 1608, behavioral analysis 1616, anomaly detection 1624, and external event impact analysis 1628.

Uses of assets may be analyzed in the context of “Uses” block 1610. For example, an SB wellness engine 1504 (FIG. 15) may provide a knowledge graph 1632, which includes linked assets and events. An example of a knowledge graph includes a representation of relationships between events and user assets. The relationship may be used to assess the impact of an event on an asset to other assets. For example, a breach event on an account may impact other accounts.

An illustrative knowledge graph may include:

### <Asset: Linked Assets><Relation>

Each asset can be linked to a list of assets by a relation (e.g., relations, impacts, belongs).

### <Facebook_account_1 □ Dropbox_account_2, Citibank_account_2> <Impacts>

In this illustration, the impact arises because the user has used a same password across multiple accounts.

### <SSN→etrade_account, Citibank_account><Impacts>

### <FF_browser_1: PC1><Belongs>

A knowledge graph 1632 may account for normal user behavior 1636, context (such as location and time) 1644, normal asset usage 1640, and external event correlation 1648.

In an illustrative example, insights and impacts may be represented as nouns that are used by policy engine 1550 to determine SB policy and enforcement.

Wellness engine 1504 (FIG. 15) may perform detection and response at different levels, and may apply progressively advanced techniques, using more data and more complex models at each stage.

As an illustrative first level, wellness engine 1504 may correlate specific wellness events and insights from these events to detect possible threats. Wellness engine 1504 may provide a set of rules and methods that use outcomes of models as nouns or states, or that may use raw sensory data. Policy engine 1550 may compute local remediations based on limited analysis. These detections may be codified as rules. Examples of rules include, for example:

If (usage_frequency(open_WiFi) is high) AND (web payments are being made)=>Recommend (automatic connection on VPN).
If (privacy_exposure_index(current_site) is high) AND (user has account) AND (account is frequently used)=>Advise (“Enter only mandatory PII”).

At a second level, wellness engine 1504 may receive additional data to assess possible threats. Additional data may include additional sensory information (both current and historical), such as events and states. The additional data may also include results from additional analysis, for example by ML models (classification and prediction). Detailed data may be processed by the WDR system, which performs deeper analysis, such as patterns developing over time, and correlations across similar small businesses. The WDR system may send alerts and recommendations to the small business administrator as necessary.

At the next level, escalation engine 1512 may receive, to the extent possible, the entire context of an event. These data may be presented in a structured manner to a security expert 1534. Expert 1534 may gain access to content based on consent by the business owner, when a wellness risk threshold is above a level set by the small business owner. The system may present to the owner a triaging objective, and the owner provides permission for the security expert to view the situation context.

Escalation may occur in cases where the risk profile of the assets and users involved is high enough, and a rules-based engine determines that it cannot provide a remediation outcome. This may be especially true in cases of high-risk assets. A wellness risk threshold may be, for example, a function of wellness event risk score, user rescore, and asset risk score.

A wellness risk profile (P_{W}) may account for a wellness event risk score (R_{E}), a user risk score (R_{U}), and an asset risk score (R_{A}), as follows:

P_{W}=R_{E}×R_{U}×R_{A}

Once a wellness risk profile goes above a specified threshold, the WDR

system escalated to security expert 1534.

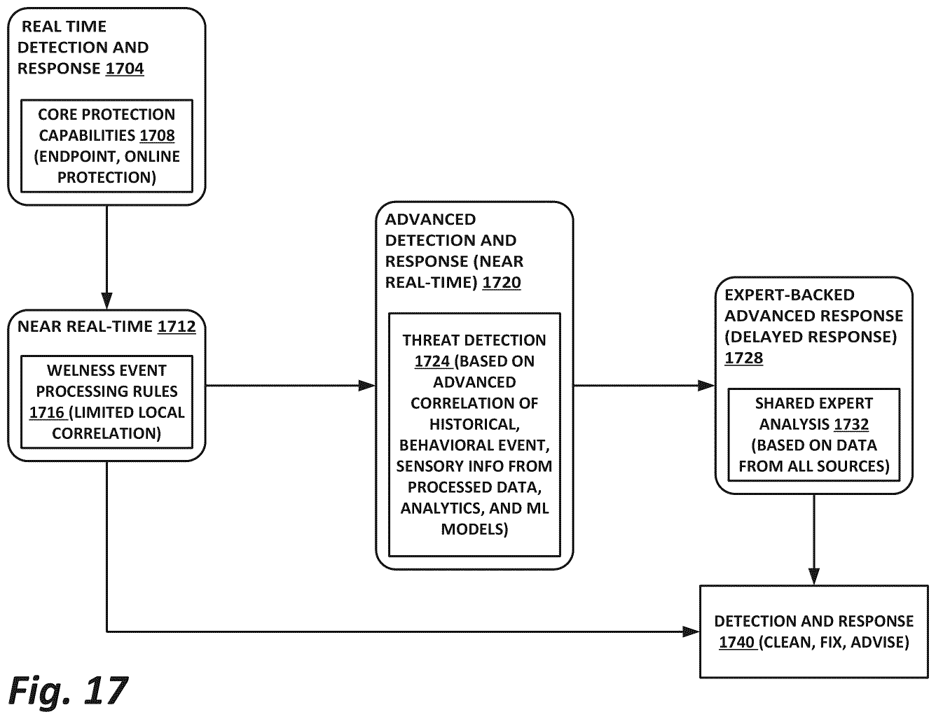

FIG. 17 is a block diagram illustration of small business event processing.

Events may be divided into several categories. Real-time detection response 1704 may include, for example, core production protection capabilities 1708. These may include, for example, endpoint and online protection.

Near real-time events 1712 may include, for example, wellness event processing rules 1716. These may be provided with limited local correlation.

Advanced detection and response 1720 may be provided in near real-time. This may include threat detection 1724. Threat detection may be based on advance correlation of historical data, behavioral events, sensory information from process data, analytics, and ML models.

An expert-backed advanced response 1728 may be provided as a delayed response. This may include shared expert analysis 1732. In this case, a security services provider may provide access to a shared expert so that small businesses do not need to retain their own dedicated expert. Expert analysis may be based on data from all sources.

Based on final expert analysis, the system may provide detection and response 1740. This may include advice or instructions to clean, fix, advise, or otherwise provide useful information for the system.

In connection with expert analysis, the expert may compute a wellness risk score, including a likelihood of the need for an expert to contact the small business owner.

A wellness orchestration console 1508 helps close the loop by taking consent from the administrator and dispatching commands to the appropriate digital assets for enforcement. Enforcement agents may execute remedial actions. Illustrative examples of actions may include:

| Area | Exemplary remediation actions |
|---|---|
| Devices | Turn on security software, enforce |
| | password/PIN, Block exe/script |
| | download, restrictions on file |
| | types, etc. |
| User behavior | Block internet on repeated visit to |
| | risky sites, show warnings on low |
| | reputation websites |
| Product configs | Enforce product configuration to |
| | policy |
| Cloud storage | Enforce recommended settings, |
| | remove access to shared folder |
| Social networks | Reset account settings and profile |
| | to lower privacy exposure, advise |
| | on posts, purge reputation |
| | sensitive content |
| 3^{rd} party apps/sites | Remove access to information, |
| | reset password |
| Email scanning | Delete attachments, archive and |
| | encrypt attachments, delete |
| | suspected phishing emails, |
| | remove emails with unsafe links |
| Accounts | Delete dormant accounts, send |
| | request to delete information, |
| | delete saved credit cards |
| Apps, extensions | Delete non-store app, delete low |
| | reputation app, delete low |
| | reputation extensions, remove |
| | permissions. |
| Identity and privacy | Start identity scan, delete |
| local footprint | sensitive information, trigger |
| | protections |
| Data footprint in | Send request to data brokers to |
| data brokers | delete user data |
| Profiles | Purge to minimum, recommend |
| | minimum |
| Reputation | Scan for company reputation, |
| | recommend actions |
| Breaches of company | Trigger remediation flow |
| identity/password, etc. | |

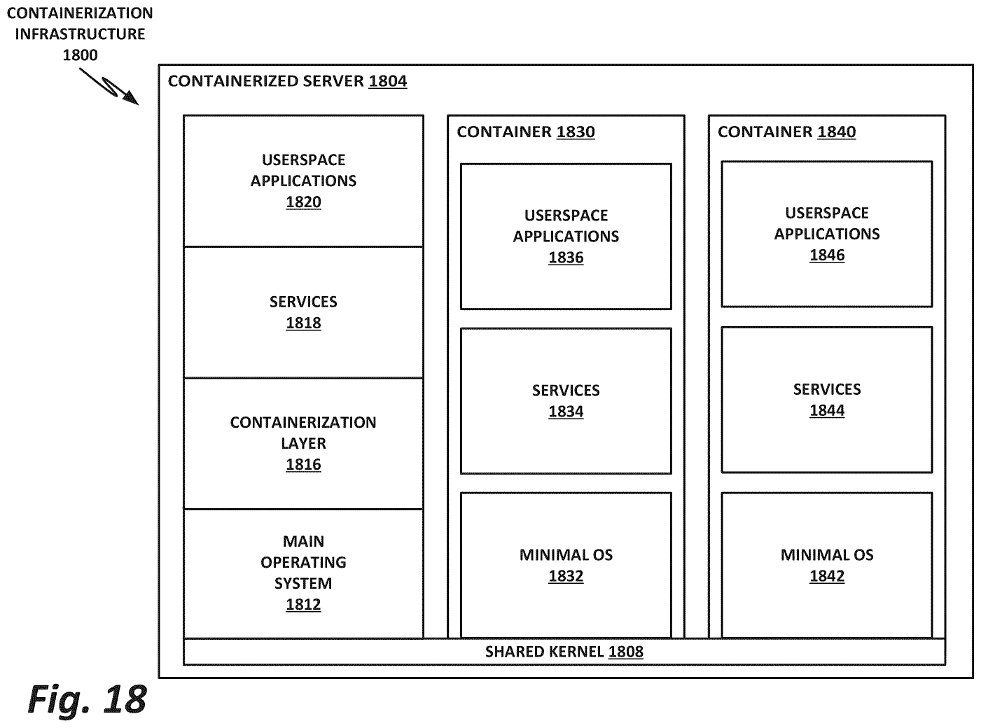

FIG. 18 is a block diagram of selected elements of a containerization infrastructure 1800. Like virtualization, containerization is a popular form of providing a guest infrastructure. Various functions described herein may be containerized, including any aspect of the WDR system. Furthermore, in some cases, user assets (e.g., desktop computing) may be provided via virtualization.

Containerization infrastructure 1800 runs on a hardware platform such as containerized server 1804. Containerized server 1804 may provide processors, memory, one or more network interfaces, accelerators, and/or other hardware resources.

Running on containerized server 1804 is a shared kernel 1808. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 1808 is main operating system 1812. Commonly, main operating system 1812 is a Unix or Linux-based operating system, although containerization infrastructure is also available for other types of systems, including Microsoft Windows systems and Macintosh systems. Running on top of main operating system 1812 is a containerization layer 1816. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer (e.g., Docker) versus one without a daemon (e.g., Podman). Such debates are outside the scope of the present specification, and when the present specification speaks of containerization, it is intended to include any containerization layer, whether it requires the use of a daemon or not.

Main operating system 1812 may also provide services 1818, which provide services and interprocess communication to userspace applications 1820.

Services 1818 and userspace applications 1820 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 1812, they inherit the same file and resource access permissions as those provided by shared kernel 1808. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 1804, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 1804).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors—especially type 1, or “bare metal,” hypervisors—provide such near-native performance that this advantage may not always be realized.

In this example, containerized server 1804 hosts two containers, namely container 1830 and container 1840.

Container 1830 may include a minimal operating system 1832 that runs on top of shared kernel 1808. Note that a minimal operating system is provided as an illustrative example, and is not mandatory. In fact, container 1830 may perform as full an operating system as is necessary or desirable. Minimal operating system 1832 is used here as an example simply to illustrate that in common practice, the minimal operating system necessary to support the function of the container (which in common practice, is a single or monolithic function) is provided.

On top of minimal operating system 1832, container 1830 may provide one or more services 1834. Finally, on top of services 1834, container 1830 may also provide userspace applications 1836, as necessary.

Container 1840 may include a minimal operating system 1842 that runs on top of shared kernel 1808. Note that a minimal operating system is provided as an illustrative example, and is not mandatory. In fact, container 1840 may perform as full an operating system as is necessary or desirable. Minimal operating system 1842 is used here as an example simply to illustrate that in common practice, the minimal operating system necessary to support the function of the container (which in common practice, is a single or monolithic function) is provided.

On top of minimal operating system 1842, container 1840 may provide one or more services 1844. Finally, on top of services 1844, container 1840 may also provide userspace applications 1846, as necessary.

Using containerization layer 1816, containerized server 1804 may run discrete containers, each one providing the minimal operating system and/or services necessary to provide a particular function. For example, containerized server 1804 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

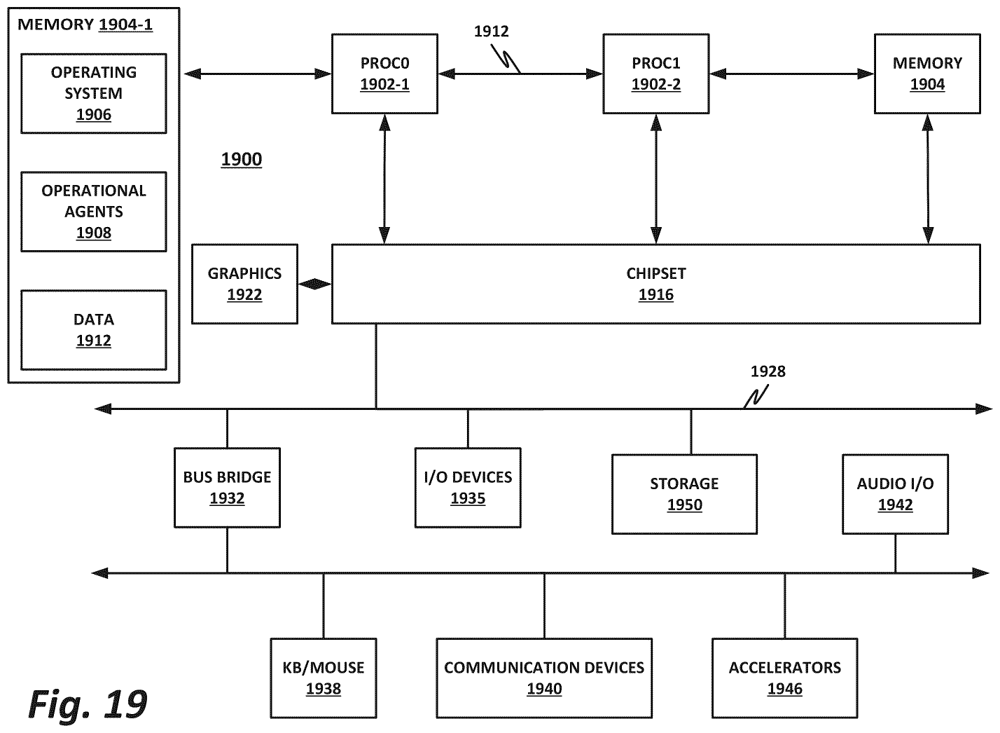

FIG. 19 is a block diagram of a hardware platform 1900. Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rackscale architecture” design, disaggregated computing resources may be virtualized into a single instance of a virtual device. In that case, all of the disaggregated resources that are used to build the virtual device may be considered part of hardware platform 1900, even though they may be scattered across a data center, or even located in different data centers.

Hardware platform 1900 is configured to provide a computing device. In various embodiments, a “computing device” may be or comprise, by way of nonlimiting example, a computer, workstation, server, mainframe, virtual machine (whether emulated or on a “bare metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 1900 is arranged in a point-to-point (PtP) configuration. This PtP configuration is popular for personal computer (PC) and server-type devices, although it is not so limited, and any other bus type may be used.

Hardware platform 1900 is an example of a platform that may be used to implement embodiments of the teachings of this specification. For example, instructions could be stored in storage 1950. Instructions could also be transmitted to the hardware platform in an ethereal form, such as via a network interface, or retrieved from another source via any suitable interconnect. Once received (from any source), the instructions may be loaded into memory 1904, and may then be executed by one or more processor 1902 to provide elements such as an operating system 1906, operational agents 1908, or data 1912.

Hardware platform 1900 may include several processors 1902. For simplicity and clarity, only processors PROC0 1902-1 and PROC1 1902-2 are shown. Additional processors (such as 2, 4, 8, 16, 24, 32, 64, or 128 processors) may be provided as necessary, while in other embodiments, only one processor may be provided. Processors may have any number of cores, such as 1, 2, 4, 8, 16, 24, 32, 64, or 128 cores.

Processors 1902 may be any type of processor and may communicatively couple to chipset 1916 via, for example, PtP interfaces. Chipset 1916 may also exchange data with other elements, such as a high performance graphics adapter 1922. In alternative embodiments, any or all of the PtP links illustrated in FIG. 19 could be implemented as any type of bus, or other configuration rather than a PtP link. In various embodiments, chipset 1916 may reside on the same die or package as a processor 1902 or on one or more different dies or packages. Each chipset may support any suitable number of processors 1902. A chipset 1916 (which may be a chipset, uncore, Northbridge, Southbridge, or other suitable logic and circuitry) may also include one or more controllers to couple other components to one or more central processor units (CPU).

Two memories, 1904-1 and 1904-2 are shown, connected to PROC0 1902-1 and PROC1 1902-2, respectively. As an example, each processor is shown connected to its memory in a direct memory access (DMA) configuration, though other memory architectures are possible, including ones in which memory 1904 communicates with a processor 1902 via a bus. For example, some memories may be connected via a system bus, or in a data center, memory may be accessible in a remote DMA (RDMA) configuration.

Memory 1904 may include any form of volatile or nonvolatile memory including, without limitation, magnetic media (e.g., one or more tape drives), optical media, flash, random access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 1904 may be used for short, medium, and/or long-term storage. Memory 1904 may store any suitable data or information utilized by platform logic. In some embodiments, memory 1904 may also comprise storage for instructions that may be executed by the cores of processors 1902 or other processing elements (e.g., logic resident on chipsets 1916) to provide functionality.

In certain embodiments, memory 1904 may comprise a relatively low-latency volatile main memory, while storage 1950 may comprise a relatively higher-latency nonvolatile memory. However, memory 1904 and storage 1950 need not be physically separate devices, and in some examples may represent simply a logical separation of function (if there is any separation at all). It should also be noted that although DMA is disclosed by way of nonlimiting example, DMA is not the only protocol consistent with this specification, and that other memory architectures are available.

Certain computing devices provide main memory 1904 and storage 1950, for example, in a single physical memory device, and in other cases, memory 1904 and/or storage 1950 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Graphics adapter 1922 may be configured to provide a human-readable visual output, such as a command-line interface (CLI) or graphical desktop such as Microsoft Windows, Apple OSX desktop, or a Unix/Linux X Window System-based desktop. Graphics adapter 1922 may provide output in any suitable format, such as a coaxial output, composite video, component video, video graphics array (VGA), or digital outputs such as digital visual interface (DVI), FPDLink, DisplayPort, or high definition multimedia interface (HDMI), by way of nonlimiting example. In some examples, graphics adapter 1922 may include a hardware graphics card, which may have its own memory and its own graphics processing unit (GPU).

Chipset 1916 may be in communication with a bus 1928 via an interface circuit. Bus 1928 may have one or more devices that communicate over it, such as a bus bridge 1932, I/O devices 1935, accelerators 1946, communication devices 1940, and a keyboard and/or mouse 1938, by way of nonlimiting example. In general terms, the elements of hardware platform 1900 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 1940 can broadly include any communication not covered by a network interface and the various I/O devices described herein. This may include, for example, various universal serial bus (USB), FireWire, Lightning, or other serial or parallel devices that provide communications.

I/O Devices 1935 may be configured to interface with any auxiliary device that connects to hardware platform 1900 but that is not necessarily a part of the core architecture of hardware platform 1900. A peripheral may be operable to provide extended functionality to hardware platform 1900, and may or may not be wholly dependent on hardware platform 1900. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of nonlimiting example.

In one example, audio I/O 1942 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 1932 may be in communication with other devices such as a keyboard/mouse 1938 (or other input devices such as a touch screen, trackball, etc.), communication devices 1940 (such as modems, network interface devices, peripheral interfaces such as PCI or PCIe, or other types of communication devices that may communicate through a network), audio I/O 1942, a data storage device 1944, and/or accelerators 1946. In alternative embodiments, any portions of the bus architectures could be implemented with one or more PtP links.

Operating system 1906 may be, for example, Microsoft Windows, Linux, UNIX, Mac OS X, iOS, MS-DOS, or an embedded or real-time operating system (including embedded or real-time flavors of the foregoing). In some embodiments, a hardware platform 1900 may function as a host platform for one or more guest systems that invoke application (e.g., operational agents 1908).

Operational agents 1908 may include one or more computing engines that may include one or more nontransitory computer-readable mediums having stored thereon executable instructions operable to instruct a processor to provide operational functions. At an appropriate time, such as upon booting hardware platform 1900 or upon a command from operating system 1906 or a user or security administrator, a processor 1902 may retrieve a copy of the operational agent (or software portions thereof) from storage 1950 and load it into memory 1904. Processor 1902 may then iteratively execute the instructions of operational agents 1908 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language such as OpenCL, FORTRAN, C, C++, JAVA, or HTML. These may be used with any compatible operating systems or operating environments. Hardware elements may be designed manually, or with a hardware description language such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

A network interface may be provided to communicatively couple hardware platform 1900 to a wired or wireless network or fabric. A “network,” as used throughout this specification, may include any communicative platform operable to exchange data or information within or between computing devices, including, by way of nonlimiting example, a local network, a switching fabric, an ad-hoc local network, Ethernet (e.g., as defined by the IEEE 802.3 standard), Fiber Channel, InfiniBand, Wi-Fi, or other suitable standard. Intel Omni-Path Architecture (OPA), TrueScale, Ultra Path Interconnect (UPI) (formerly called QuickPath Interconnect, QPI, or KTI), FibreChannel, Ethernet, FibreChannel over Ethernet (FCoE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 1900 may be virtualized, in particular the processor(s) and memory. For example, a virtualized environment may run on OS 1906, or OS 1906 could be replaced with a hypervisor or virtual machine manager. In this configuration, a virtual machine running on hardware platform 1900 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 19 may be combined in a SoC architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. An example of such an embodiment is provided in FIGURE QC. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

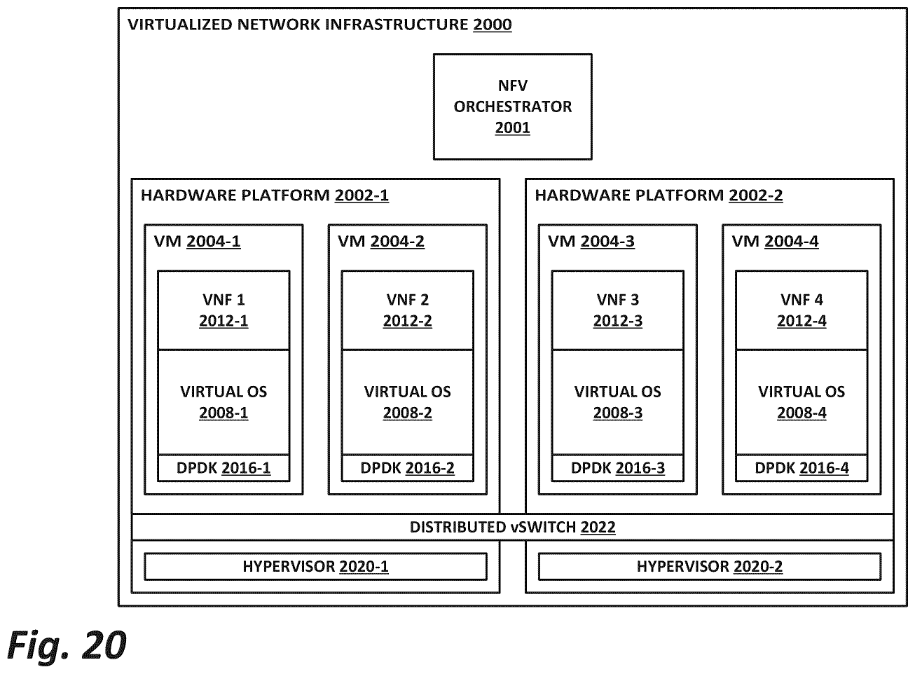

FIG. 20 is a block diagram of a NFV infrastructure 2000. NFV is an example of virtualization, and the virtualization infrastructure here can also be used to realize traditional VMs. Various functions described above may be realized as containers, including any aspect of the WDR system.

NFV is generally considered distinct from software defined networking (SDN), but they can interoperate together, and the teachings of this specification should also be understood to apply to SDN in appropriate circumstances. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be VMs). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 2000. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 20, an NFV orchestrator 2001 may manage several VNFs 2012 running on an NFVI 2000. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 2001 a valuable system resource. Note that NFV orchestrator 2001 may provide a browser-based or graphical configuration interface, and in some embodiments may be integrated with SDN orchestration functions.

Note that NFV orchestrator 2001 itself may be virtualized (rather than a special-purpose hardware appliance). NFV orchestrator 2001 may be integrated within an existing SDN system, wherein an operations support system (OSS) manages the SDN. This may interact with cloud resource management systems (e.g., OpenStack) to provide NFV orchestration. An NFVI 2000 may include the hardware, software, and other infrastructure to enable VNFs to run. This may include a hardware platform 2002 on which one or more VMs 2004 may run. For example, hardware platform 2002-1 in this example runs VMs 2004-1 and 2004-2. Hardware platform 2002-2 runs VMs 2004-3 and 2004-4. Each hardware platform 2002 may include a respective hypervisor 2020, virtual machine manager (VMM), or similar function, which may include and run on a native (bare metal) operating system, which may be minimal so as to consume very few resources. For example, hardware platform 2002-1 has hypervisor 2020-1, and hardware platform 2002-2 has hypervisor 2020-2.

Hardware platforms 2002 may be or comprise a rack or several racks of blade or slot servers (including, e.g., processors, memory, and storage), one or more data centers, other hardware resources distributed across one or more geographic locations, hardware switches, or network interfaces. An NFVI 2000 may also include the software architecture that enables hypervisors to run and be managed by NFV orchestrator 2001.

Running on NFVI 2000 are VMs 2004, each of which in this example is a VNF providing a virtual service appliance. Each VM 2004 in this example includes an instance of the Data Plane Development Kit (DPDK) 2016, a virtual operating system 2008, and an application providing the VNF 2012. For example, VM 2004-1 has virtual OS 2008-1, DPDK 2016-1, and VNF 2012-1. VM 2004-2 has virtual OS 2008-2, DPDK 2016-2, and VNF 2012-2. VM 2004-3 has virtual OS 2008-3, DPDK 2016-3, and VNF 2012-3. VM 2004-4 has virtual OS 2008-4, DPDK 2016-4, and VNF 2012-4.

Virtualized network functions could include, as nonlimiting and illustrative examples, firewalls, intrusion detection systems, load balancers, routers, session border controllers, DPI services, network address translation (NAT) modules, or call security association.

The illustration of FIG. 20 shows that a number of VNFs 2004 have been provisioned and exist within NFVI 2000. This FIGURE does not necessarily illustrate any relationship between the VNFs and the larger network, or the packet flows that NFVI 2000 may employ.

The illustrated DPDK instances 2016 provide a set of highly-optimized libraries for communicating across a virtual switch (vSwitch) 2022. Like VMs 2004, vSwitch 2022 is provisioned and allocated by a hypervisor 2020. The hypervisor uses a network interface to connect the hardware platform to the data center fabric (e.g., a host fabric interface (HFI)). This HFI may be shared by all VMs 2004 running on a hardware platform 2002. Thus, a vSwitch may be allocated to switch traffic between VMs 2004. The vSwitch may be a pure software vSwitch (e.g., a shared memory vSwitch), which may be optimized so that data are not moved between memory locations, but rather, the data may stay in one place, and pointers may be passed between VMs 2004 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 2022 is illustrated, wherein vSwitch 2022 is shared between two or more physical hardware platforms 2002.

The foregoing outlines features of several embodiments so that those skilled in the art may better understand various aspects of the present disclosure. The foregoing detailed description sets forth examples of apparatuses, methods, and systems relating to a system providing small business security services accordance with one or more embodiments of the present disclosure. Features such as structure(s), function(s), and/or characteristic(s), for example, are described with reference to one embodiment as a matter of convenience; various embodiments may be implemented with any suitable one or more of the described features.

As used throughout this specification, the phrase “an embodiment” is intended to refer to one or more embodiments. Furthermore, different uses of the phrase “an embodiment” may refer to different embodiments. The phrases “in another embodiment” or “in a different embodiment” refer to an embodiment different from the one previously described, or the same embodiment with additional features. For example, “in an embodiment, features may be present. In another embodiment, additional features may be present.” The foregoing example could first refer to an embodiment with features A, B, and C, while the second could refer to an embodiment with features A, B, C, and D, with features, A, B, and D, with features, D, E, and F, or any other variation.

In the foregoing description, various aspects of the illustrative implementations may be described using terms commonly employed by those skilled in the art to convey the substance of their work to others skilled in the art. It will be apparent to those skilled in the art that the embodiments disclosed herein may be practiced with only some of the described aspects. For purposes of explanation, specific numbers, materials, and configurations are set forth to provide a thorough understanding of the illustrative implementations. In some cases, the embodiments disclosed may be practiced without the specific details. In other instances, well-known features are omitted or simplified so as not to obscure the illustrated embodiments.

For the purposes of the present disclosure and the appended claims, the article “a” refers to one or more of an item. The phrase “A or B” is intended to encompass the “inclusive or,” e.g., A, B, or (A and B). “A and/or B” means A, B, or (A and B). For the purposes of the present disclosure, the phrase “A, B, and/or C” means A, B, C, (A and B), (A and C), (B and C), or (A, B, and C).

The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a nonvolatile memory. Thus, for example, an “engine” as described above could include instructions encoded within a volatile or nonvolatile memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, nontransitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, nontransitory computer-readable storage media having stored thereon executable instructions that, when executed, cause a hardware platform or other computing system, to carry out a method or procedure. For example, the instructions could be executable object code, including software instructions executable by a processor. The one or more tangible, nontransitory computer-readable storage media could include, by way of illustrative and nonlimiting example, a magnetic media (e.g., hard drive), a flash memory, a ROM, optical media (e.g., CD, DVD, Blu-Ray), nonvolatile random access memory (NVRAM), nonvolatile memory (NVM) (e.g., Intel 3D Xpoint), or other nontransitory memory.

There are also provided herein certain methods, illustrated for example in flow charts and/or signal flow diagrams. The order or operations disclosed in these methods discloses one illustrative ordering that may be used in some embodiments, but this ordering is no intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected element. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

To aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

What is claimed is:

1-62. (canceled)

63. A computer-implemented method of providing security services for an enterprise, comprising:
computing, for the enterprise, a quantitative user-centric security posture, wherein computing the quantitative user-centric security posture comprises calculating, for a user, a quantitative user risk profile according to a combination of user role, user privileges, user behavior, and digital assets assigned to a user and owned by the enterprise.

64. The computer-implemented method of claim 63, wherein the enterprise is a small or medium-sized business, family, church, religious organization, club, or educational institution.

65. The computer-implemented method of claim 64, wherein the user is an employee, agent, or member of the enterprise.

66. The computer-implemented method of claim 63, wherein digital assets further include assets owned by the user and used for enterprise operations.

67. The computer-implemented method of claim 63, wherein digital assets are selected from the group consisting of electronic devices, applications, identities, shared sensitive information, online accounts, and online services.

68. The computer-implemented method of claim 63, wherein computing a user risk profile comprises computing a sum of weighted scores for a plurality of risk categories.

69. The computer-implemented method of claim 68, wherein the weighted scores are uniformly values between 0 and 1.

70. The computer-implemented method of claim 68, wherein the sum of weighted scores total substantially 1.0.

71. The computer-implemented method of claim 68, wherein the risk categories comprise security, privacy, and identity.

72. The computer-implemented method of claim 63, wherein the quantitative user risk profile for the user numerically represents a combined security state of digital assets assigned to the user.

73. The computer-implemented method of claim 63, further comprising defining a user-specific digital protection policy for the user based on the quantitative user risk profile.

74. The computer-implemented method of claim 73, further comprising presenting to a human security operator an actional graphical display comprising a set of prioritized protection actions to enforce the specific digital protection policy.

75. The computer-implemented method of claim 63, further comprising providing a weekly report to show remedial actions for one or more users, groups, or subgroups to take to remediate one or more problematic digital protection states.

76. The computer-implemented method of claim 75, wherein the weekly report further provides digital protection score trends and remedial action trends.

77. One or more tangible, nontransitory computer-readable storage media having stored thereon executable instructions to:
compute, for an enterprise, a quantitative user-centric security posture, wherein computing the quantitative user-centric security posture comprises calculating, for a user, a quantitative user risk profile according to a combination of user role, user privileges, user behavior, and digital assets assigned to a user and owned by the enterprise.

78. The one or more tangible, nontransitory computer-readable storage media of claim 77, wherein the instructions to provide a weekly report to show remedial actions for one or more users, groups, or subgroups to take to remediate one or more problematic digital protection states.

79. The one or more tangible, nontransitory computer-readable storage media of claim 78, wherein the weekly report further provides digital protection score trends and remedial action trends.

80. A computing apparatus, comprising:
a hardware platform comprising a processor circuit and a memory;
and instructions encoded within the memory to instruct the processor circuit to compute, for an enterprise, a quantitative user-centric security posture, wherein computing the quantitative user-centric security posture comprises calculating, for a user, a quantitative user risk profile according to a combination of user role, user privileges, user behavior, and digital assets assigned to a user and owned by the enterprise.

81. The computing apparatus of claim 80, wherein the user is an employee, agent, or member of the enterprise.

82. The computing apparatus of claim 80, wherein digital assets are selected from the group consisting of electronic devices, applications, identities, shared sensitive information, online accounts, and online services.
